SEQUENCE LISTING (14 sequences)

SEQ ID NO: 1 - protein, 8 aa, Artificial
  digested BSA
AEFVEVTK

SEQ ID NO: 2 - protein, 12 aa, Artificial
  digested BSA
TVMENFVAFVDK

SEQ ID NO: 3 - protein, 10 aa, Artificial
  digested BSA
LVNELTEFAK

SEQ ID NO: 4 - protein, 10 aa, Artificial
  digested BSA
FKDLGEEHFK

SEQ ID NO: 5 - protein, 13 aa, Artificial
  digested BSA
DAFLGSFLYEYSR

SEQ ID NO: 6 - protein, 13 aa, Artificial
  digested BSA
LGEYGFQNALIVR

SEQ ID NO: 7 - protein, 11 aa, Artificial
  digested BSA
HLVDEPQNLIK

SEQ ID NO: 8 - protein, 7 aa, Artificial
  commercially available
DRVYIHP

SEQ ID NO: 9 - protein, 9 aa, Artificial
  commercially available
RPPGFSPFR

SEQ ID NO: 10 - protein, 8 aa, Artificial
  commercially available
DRVYIHPF

SEQ ID NO: 11 - protein, 10 aa, Artificial
  commercially available
DRVYIHPFHL

SEQ ID NO: 12 - protein, 14 aa, Artificial
  commercially available
DRVYIHPFHLLVYS

SEQ ID NO: 13 - protein, 16 aa, Artificial
  commercially available
WLTGPQLADLYHSLMK

SEQ ID NO: 14 - protein, 23 aa, Artificial
  commercially available
YPIVSIEDPFAEDDWEAWSHFFK

(19) United States
(12) Patent Application Publication
(10) Pub. No.: US 2012/0282370 A1
(43) Pub. Date: Nov. 8, 2012

(54) SPARKLING BEVERAGE AND METHOD OF PRODUCING SAME

(75) Inventors: Tatsuji Kimura, Shizuoka (JP); Shigeki Araki, Shizuoka (JP); Koji Takazumi, Shizuoka (JP); Takashi Iimure, Gunma (JP)

(73) Assignee: SAPPORO BREWERIES LIMITED, Tokyo (JP)

(21) Appl. No.: 13/504,288

(22) PCT Filed: Oct. 21, 2010
(86) PCT No.: PCT/JP2010/068637

§ 371 Date: Apr. 26, 2012

(30) Foreign Application Priority Data
Oct. 27, 2009 (JP) 2009-246873
Mar. 2, 2010 (JP) 2010-045324

(51) Int. Cl. C12C 5/02; C12C 11/00

(52) U.S. Cl. 426/13; 426/592; 426/656

(57) ABSTRACT

Provided are a sparkling beverage having effectively improved foam properties and a method of producing the same. The sparkling beverage has improved foam properties through an increase in content of a hydrophobic polypeptide or contains a hydrophobic polypeptide in an amount of 1.1 g/L or more. When the sparkling beverage is a sparkling alcoholic beverage, a method of producing the sparkling alcoholic beverage includes: a pre-fermentation step (10) of preparing a pre-fermentation solution using a raw material containing barley; and a fermentation step (20) of conducting alcoholic fermentation by adding a yeast to the pre-fermentation solution, in which foam properties of the sparkling alcoholic beverage are improved by treating the barley with a protease.

### TECHNICAL FIELD

The present invention relates to a sparkling beverage and a method of producing the same, and more particularly, to an improvement in foam properties of a sparkling beverage.

### BACKGROUND ART

Conventionally, for example, Patent Literature 1 describes that a substance for improving foam-forming property and foam-stability, such as a saponin extracted from a plant, is used in order to improve foam properties of a sparkling alcoholic beverage.

Meanwhile, Patent Literature 2 describes that a protease having a certain activity is used in producing a sparkling alcoholic beverage. In this regard, however, it has been conventionally recognized that use of the protease reduces foam-stability of the sparkling alcoholic beverage, as described in Patent Literature 2.

### PRIOR ART DOCUMENT

### Patent Document

### [Patent Document 1] WO 2004/000990 A1

### [Patent Document 2] JP 2008-109861 A

### DISCLOSURE OF THE INVENTION

### Problems to be Solved by the Invention

In the technology described in Patent Literature 1 above, although the foam properties of the sparkling alcoholic beverage were able to be improved, it was necessary to use the substance for improving foam-forming property and foam-stability specialized for the purpose of improving the foam properties.

In the technology described in Patent Literature 2 above, there is a description that degradation of a foaming protein due to the use of the protease is suppressed, but there is no description of an improvement in foam-stability.

The present invention has been made in light of the problems, and it is an object of the present invention to provide a sparkling beverage having effectively improved foam properties and a method of producing the same.

### Means for Solving the Problems

A sparkling beverage according to an embodiment of the present invention for solving the problems includes a hydrophobic polypeptide in an amount of 1.1 g/L or more. According to the present invention, there is provided a sparkling beverage having effectively improved foam properties.

Further, the hydrophobic polypeptide may have a sum of modified Rekker's constants of 10.3 or more. Further, the hydrophobic polypeptide may have a proline content of 13.5 mol % or more.

Further, the hydrophobic polypeptide may include a polypeptide having a molecular weight of 10 to 25 kDa. Further, the hydrophobic polypeptide may be a polypeptide obtained from barley.

A method of producing a sparkling beverage according to an embodiment of the present invention for solving the problems uses a raw material containing barley, and includes treating the barley with a protease to produce the sparkling beverage having an increased content of a hydrophobic polypeptide compared to a case of not treating the barley with the protease. According to the present invention, there is provided a method of producing a sparkling beverage having effectively improved foam properties.

Further, the raw material may further include barley malt, and the treating of the barley with the protease may be carried out without mixing the barley with the barley malt. Further, the treating of the barley with the protease may be carried out to produce the sparkling beverage having a content of the hydrophobic polypeptide increased by 0.05 g/L or more compared to the case of not treating the barley with the protease.

A method of producing a sparkling beverage according to an embodiment of the present invention for solving the problems uses a raw material containing barley and barley malt, and includes: a barley treatment step of keeping, in a first tank, a barley composition containing the barley and a protease at a temperature at which the protease acts; a malt treatment step of keeping, in a second tank, a malt composition containing the barley malt at a temperature at which an enzyme contained in the barley malt acts, in parallel with the barley treatment step; and a mixing step of mixing the barley composition treated with the protease in the barley treatment step with the malt composition treated with the enzyme in the malt treatment step. According to the present invention, there is provided a method of producing a sparkling beverage having effectively improved foam properties.

An agent for improving foam properties according to an embodiment of the present invention for solving the problems includes a hydrophobic polypeptide as an active ingredient. According to the present invention, there is provided an agent for improving foam properties capable of effectively improving foam properties of a sparkling beverage.

A method of producing a sparkling beverage according to an embodiment of the present invention for solving the problems includes using the agent for improving foam properties. According to the present invention, there is provided a method of producing a sparkling beverage having effectively improved foam properties.

### Effect of the Invention

According to the present invention, it is provided the sparkling beverage having effectively improved foam properties and the method of producing the same.

### BRIEF DESCRIPTION OF THE DRAWINGS

FIG. 1 A diagram illustrating major steps included in an example of a method of producing a sparkling alcoholic beverage according to an embodiment of the present invention.

FIG. 2A A diagram illustrating an example of a chromatogram obtained by analyzing a sparkling alcoholic beverage produced using barley not treated with a protease by reverse phase chromatography in an Example according to an embodiment of the present invention.

FIG. 2B A diagram illustrating an example of a chromatogram obtained by analyzing a sparkling alcoholic beverage produced using barley treated with a protease P1 by reverse phase chromatography in an Example according to an embodiment of the present invention.

FIG. 2C A diagram illustrating an example of a chromatogram obtained by analyzing a sparkling alcoholic beverage produced using barley treated with a protease P5 by reverse phase chromatography in an Example according to an embodiment of the present invention.

FIG. 2D A diagram illustrating an example of a chromatogram obtained by analyzing a sparkling alcoholic beverage produced using barley treated with a protease P7 by reverse phase chromatography in an Example according to an embodiment of the present invention.

FIG. 3 A graph illustrating a correlation between a content of a hydrophobic polypeptide and an NIBEM value, obtained in an Example according to an embodiment of the present invention.

FIG. 4 A table illustrating a relation between a type of a protease and each of a content of a hydrophobic polypeptide and an NIBEM value, obtained in an Example according to an embodiment of the present invention.

FIG. 5 A table illustrating results of analyzing an amino acid composition of a hydrophobic polypeptide in an Example according to an embodiment of the present invention.

FIG. 6A A diagram illustrating an example of a chromatogram obtained by gel filtration chromatography in an Example according to an embodiment of the present invention.

FIG. 6B A partially enlarged diagram illustrating the chromatogram illustrated in FIG. 6A.

FIG. 7A A diagram illustrating another example of a chromatogram obtained by gel filtration chromatography in an Example according to an embodiment of the present invention.

FIG. 7B A diagram illustrating still another example of a chromatogram obtained by gel filtration chromatography in an Example according to an embodiment of the present invention.

FIG. 8A A diagram illustrating an example of a chromatogram obtained by analyzing a first fraction of a pre-fermentation solution produced using barley not treated with a protease by reverse phase chromatography in an Example according to an embodiment of the present invention.

FIG. 8B A diagram illustrating an example of a chromatogram obtained by analyzing a first fraction of a pre-fermentation solution produced using barley treated with a protease P5 by reverse phase chromatography in an Example according to an embodiment of the present invention.

FIG. 9A A diagram illustrating an example of a chromatogram obtained by analyzing a second fraction of a pre-fermentation solution produced using barley not treated with a protease by reverse phase chromatography in an Example according to an embodiment of the present invention.

FIG. 9B A diagram illustrating an example of a chromatogram obtained by analyzing a second fraction of a pre-fermentation solution produced using barley treated with a protease P5 by reverse phase chromatography in an Example according to an embodiment of the present invention.

FIG. 10A A diagram illustrating an example of a chromatogram obtained by analyzing 0 to 40% saturated ammonium sulfate precipitates of a barley extract by gel filtration chromatography in an Example according to an embodiment of the present invention.

FIG. 10B A diagram illustrating an example of a chromatogram obtained by analyzing 40 to 75% saturated ammonium sulfate precipitates of a barley extract by gel filtration chromatography in an Example according to an embodiment of the present invention.

FIG. 11 A diagram illustrating an example of a chromatogram obtained by cation exchange chromatography in an Example according to an embodiment of the present invention.

FIG. 12 A graph illustrating a relation between an amount of a protease added and each of an NIBEM value and foam adherence, obtained in an Example according to an embodiment of the present invention.

FIG. 13 A table illustrating a relation between an amount of a protease added and each of a content of a hydrophobic polypeptide and an NIBEM value, obtained in an Example according to an embodiment of the present invention.

FIG. 14 A graph illustrating a relation between an amount of a protease added and an evaluation result of a sensory test, obtained in an Example according to an embodiment of the present invention.

FIG. 15 A graph illustrating a relation between an amount of barley used and each of an NIBEM value and foam adherence, obtained in an Example according to an embodiment of the present invention.

FIG. 16 A table illustrating modified Rekker's constants for amino acids.

FIG. 17 A table illustrating results of evaluating a correlation between a sum of modified Rekker's constants and a retention time in reverse phase chromatography for a plurality of peptides in an Example according to an embodiment of the present invention.

FIG. 18 A graph illustrating a linear relation between a sum of modified Rekker's constants and a retention time in reverse phase HPLC, obtained in an Example according to an embodiment of the present invention.

FIG. 19A A diagram illustrating an example of a diagram of enzyme treatment in an Example according to an embodiment of the present invention.

FIG. 19B A diagram illustrating another example of a diagram of enzyme treatment in an Example according to an embodiment of the present invention.

FIG. 20 A graph illustrating an example of evaluation results of sensory tests in an Example according to an embodiment of the present invention.

FIG. 21 A graph illustrating an example of evaluation results of NIBEM values in an Example according to an embodiment of the present invention.

FIG. 22 A graph illustrating another example of evaluation results of sensory tests in an Example according to an embodiment of the present invention.

### MODE FOR CARRYING OUT THE INVENTION

An embodiment of the present invention is described below. It should be noted that the present invention is not limited to this embodiment.

First, a sparkling beverage according to this embodiment (hereinafter, referred to as “beverage of the present invention”) is described. In this embodiment, the sparkling beverage is a beverage containing carbon dioxide gas and having, for example, a foam-forming property by which a foam layer is formed in the upper liquid level when poured into a vessel such as a glass and foam-stability by which the formed foam is held for a predetermined period of time or longer. Specifically, the sparkling beverage has an NIBEM value of 50 seconds or more, which is determined by a European Brewery Convention (EBC) method.

The sparkling beverage may be, for example, a sparkling alcoholic beverage. In this embodiment, the sparkling alcoholic beverage is a sparkling beverage having the foam properties as described above and containing, for example, ethanol at a concentration of 1% by volume or more. Specific examples of the sparkling alcoholic beverage include beers, low-malt beers, and sparkling alcoholic beverages obtained by adding spirits to the low-malt beers (liqueurs defined in Liquor Tax Act in Japan).

Further, the sparkling beverage may also be, for example, a sparkling non-alcoholic beverage. In this embodiment, the sparkling non-alcoholic beverage is a sparkling beverage having the foam properties as described above and containing, for example, ethanol at a concentration of less than 1% by volume.

It should be noted that the NIBEM value is used as an indicator of foam-stability of a sparkling alcoholic beverage such as a beer. The NIBEM value is evaluated as a time (seconds) required for reducing a height of foam, which is formed when a sparkling beverage is poured into a predetermined vessel, by a predetermined amount. Thus, as the NIBEM value becomes higher, the foam-stability of the sparkling beverage becomes higher (excellent foam-stability).

In this embodiment, examples of realizing the beverage of the present invention as a sparkling alcoholic beverage are mainly described.

The beverage of the present invention is a sparkling beverage having improved foam properties through an increase in content of a hydrophobic polypeptide. The hydrophobic polypeptide is a polypeptide that improves the foam properties of a sparkling beverage newly found as a result of intensive studies made by the inventors of the present invention.

That is, protein Z having a molecular weight of about 40 kDa (hereinafter, referred to as “40-kDa protein”) and lipid transfer protein 1 (LTP1) have been conventionally known as proteins for improving the foam properties of a beer. On the other hand, the inventors of the present invention have independently made intensive studies, and consequently found the hydrophobic polypeptide according to the present invention as a novel polypeptide that improves the foam properties, which is different from the 40-kDa protein and LTP1.

The hydrophobic polypeptide is obtained, for example, from barley. That is, the hydrophobic polypeptide may be a polypeptide obtained by treating barley with a protease. More specifically, the hydrophobic polypeptide is, for example, a polypeptide whose yield is increased by treating barley with a protease, compared to the case where the barley is not treated with the protease.

The hydrophobic polypeptide is detected in the range of a retention time exhibiting hydrophobicity having a relatively large interaction with a stationary phase in reverse phase chromatography using a column including the stationary phase having low polarity and a mobile phase having high polarity.

The hydrophobicity of the hydrophobic polypeptide may also be represented by, for example, a sum of modified Rekker's constants (Reference 1: R. F. Rekker, The Hydrophobic Fragmental Constant, Elsevier, Amsterdam, 1977, p. 301, Reference 2: Tatsuru Sasagawa et al., Prediction of Peptide Retention Times in Reversed-Phase High-Performance Liquid Chromatography during Linear Gradient elution, Journal of Chromatography 240 (1982), 329-340, Reference 3: Toshiaki Isobe, Norio Okuyama, Biophysical Chemistry Vol. 30, No. 1 (1986)).

The sum of modified Rekker's constants of the hydrophobic polypeptide is expressed by “ΣDⱼnᵢⱼ”. In the expression, “Dⱼ” represents a modified Rekker's constant of each amino acid for constituting the hydrophobic polypeptide. Further, “nᵢⱼ” represents the number of amino acid residues for constituting the hydrophobic polypeptide. The hydrophobic polypeptide may also be a polypeptide having a sum of modified Rekker's constants of 10.3 or more. The hydrophobic polypeptide may also be a polypeptide having a sum of modified Rekker's constants of 19.7 or more. The upper limit of the sum of modified Rekker's constants of the hydrophobic polypeptide is not particularly limited as long as the hydrophobic polypeptide can be dissolved in the beverage of the present invention, and may be, for example, 400.

The hydrophobic polypeptide may also be a polypeptide having a proline content of 13.5 mol % or more. That is, in this case, the hydrophobic polypeptide may be a polypeptide having a sum of modified Rekker's constants of 10.3 or more and having a proline content of 13.5 mol % or more. Further, the proline content of the hydrophobic polypeptide is, for example, preferably 14.5 mol % or more, more preferably 17.0 mol % or more. The proline content of the hydrophobic polypeptide may also be, for example, 40.0 mol % or less.

The hydrophobic polypeptide may contain a polypeptide having a molecular weight of 10 to 25 kDa. That is, in this case, the beverage of the present invention contains the hydrophobic polypeptide having a molecular weight of 10 to 25 kDa.

The molecular weight of the hydrophobic polypeptide is measured, for example, by gel filtration chromatography. That is, the hydrophobic polypeptide having a molecular weight of 10 to 25 kDa is, for example, a polypeptide detected at a retention time corresponding to a molecular weight of 10 to 25 kDa in gel filtration chromatography using a column including a porous stationary phase that works as a molecular sieve.

The hydrophobic polypeptide may also contain, for example, a polypeptide having a molecular weight of 10 to 15 kDa. More specifically, the hydrophobic polypeptide may contain, for example, a polypeptide having a molecular weight of about 10 kDa.

The hydrophobic polypeptide may also contain, for example, a polypeptide having a molecular weight of 15 to 25 kDa. More specifically, the hydrophobic polypeptide may contain, for example, a polypeptide having a molecular weight of more than 15 kDa and 25 kDa or less, in particular, a polypeptide having a molecular weight of about 20 kDa.

The hydrophobic polypeptide may also contain, for example, a polypeptide having a molecular weight of 10 to 15 kDa (e.g., about 10 kDa) and a polypeptide having a molecular weight of 15 to 25 kDa (e.g., about 20 kDa).

That is, in those cases, the beverage of the present invention may contain one or both of the polypeptide having a molecular weight of 10 to 15 kDa (e.g., about 10 kDa) and the polypeptide having a molecular weight of 15 to 25 kDa (e.g., about 20 kDa). The hydrophobic polypeptide may also contain, for example, a polypeptide having an isoelectric point of 4.9 to 5.4.

The hydrophobic polypeptide is a polypeptide capable of increasing the NIBEM value of the sparkling alcoholic beverage. That is, the hydrophobic polypeptide may be, for example, a polypeptide that increases the NIBEM value of the sparkling alcoholic beverage by 10 seconds or more through its increase in content in the sparkling alcoholic beverage by 0.05 g/L or more.

The content of the hydrophobic polypeptide in the beverage of the present invention is not particularly limited as long as desired foam properties are accomplished. That is, the beverage of the present invention may contain the hydrophobic polypeptide in an amount of 1.1 g/L or more. Further, the content of the hydrophobic polypeptide may be 1.2 g/L or more, or may also be 1.3 g/L or more.

More specifically, the beverage of the present invention may be, for example, a sparkling beverage containing the hydrophobic polypeptide having a sum of modified Rekker's constants of 10.3 or more in an amount of 1.1 g/L or more. The beverage of the present invention may also be, for example, a sparkling beverage containing the hydrophobic polypeptide having a proline content of 13.5 mol % or more in an amount of 1.1 g/L or more. The beverage of the present invention may also be, for example, a sparkling beverage containing the hydrophobic polypeptide having a sum of modified Rekker's constants of 10.3 or more and having a proline content of 13.5 mol % or more in an amount of 1.1 g/L or more. In those cases, the proline content of the hydrophobic polypeptide is preferably 14.5 mol % or more, and more preferably 17.0 mol % or more, as described above.

The foam properties of the beverage of the present invention are improved as the content of the hydrophobic polypeptide is increased. Examples of the foam properties include foam-forming property, foam-stability, and foam adherence. Therefore, for example, the foam-stability of the beverage of the present invention is improved as the content of the hydrophobic polypeptide is increased. That is, in this case, the NIBEM value of the beverage of the present invention is increased.

The beverage of the present invention may be, for example, a sparkling alcoholic beverage having an NIBEM value equal to or higher than a given value. That is, for example, the NIBEM value of the beverage of the present invention may be 300 seconds or more, may be 320 seconds or more, or may be 350 seconds or more.

Subsequently, a method according to this embodiment (hereinafter, referred to as “method of the present invention”) is described. The method of the present invention may be a method of producing a sparkling beverage. In this case, the beverage of the present invention can be preferably produced by the method of the present invention. The method of the present invention may also be a method of improving foam properties of a sparkling beverage.

The method of the present invention may be, for example, a method of producing a sparkling beverage having improved foam properties by increasing the content of a hydrophobic polypeptide. The method of the present invention may also be, for example, a method of improving foam properties of a sparkling beverage by increasing the content of a hydrophobic polypeptide.

A method of increasing the content of a hydrophobic polypeptide is not particularly limited. For example, it is possible to employ a method of treating barley contained in a raw material with a protease in a process of producing a sparkling beverage, or a method of adding a hydrophobic polypeptide obtained in advance.

The method of the present invention may be, for example, a method of producing a sparkling beverage using a raw material containing barley, the method including treating the barley with a protease to produce the sparkling beverage having an increased content of a hydrophobic polypeptide. That is, in this case, in the method of the present invention, the content of the hydrophobic polypeptide in the sparkling beverage is increased, by treating the barley in the raw material with the protease, compared to the case where the barley contained is not treated with the protease. As described above, when the barley is used as the raw material, the foam properties of the sparkling beverage to be produced can be effectively improved by treating the barley with the protease in a step of processing the raw material.

The method of the present invention may also be, for example, a method of improving foam properties of a sparkling beverage to be produced using a raw material containing barley, the method including treating the barley with a protease to improve the foam properties of the sparkling beverage.

More specifically, in the method of the present invention, for example, a sparkling beverage containing a hydrophobic polypeptide in an amount of 1.1 g/L or more can be produced by treating barley with a protease to increase the content of the hydrophobic polypeptide. The method of the present invention may also be, for example, a method of improving foam properties of a sparkling beverage by treating barley contained in a raw material with a protease to increase the content of a hydrophobic polypeptide in the sparkling beverage to 1.1 g/L or more. Further, the content of the hydrophobic polypeptide in the sparkling beverage is preferably 1.2 g/L or more, more preferably 1.3 g/L or more.

The method of the present invention may also be, for example, a method of producing a sparkling beverage using a raw material containing barley and barley malt, the method including treating the barley with a protease without mixing the barley with the barley malt to produce the sparkling beverage having an increased content of a hydrophobic polypeptide.

That is, in this case, a barley composition containing the hydrophobic polypeptide is prepared by treating the barley with the protease, and then the barley composition is mixed with the barley malt. Therefore, the effect of the protease on the barley malt can be effectively avoided, together with efficiently generating the hydrophobic polypeptide, by selectively treating, with the protease, only the barley among the barley and the barley malt contained in the raw material.

The method of the present invention may also be, for example, a method of producing a sparkling beverage having a content of a hydrophobic polypeptide increased by 0.05 g/L or more by treating of barley with a protease.

That is, in this case, in the method of the present invention, the content of the hydrophobic polypeptide in the sparkling beverage is increased by 0.05 g/L or more by treating the barley contained in the raw material with the protease, compared to the case where the barley is not treated with the protease.

The treatment of the barley with the protease is carried out by mixing the barley and the protease with water and keeping the resulting mixture at a temperature at which the protease acts. The temperature for the treatment is not particularly limited as long as the protease acts, and may be, for example, 30 to 70° C., preferably 30 to 65° C. A period of time for keeping the mixture at the temperature for the treatment is not particularly limited as long as the barley is sufficiently treated with the protease, and may be, for example, 1 to 120 minutes.

When the raw material containing barley and barley malt is used in the method of the present invention, for example, the treatment with the protease can be carried out by keeping the mixture containing the barley, barley malt, protease, and water at a temperature at which the protease acts.

The method of the present invention may also be, for example, a method of producing a sparkling beverage using a raw material containing barley and barley malt, the method including: a barley treatment step of keeping, in a first tank, a barley composition containing the barley and a protease at a temperature at which the protease acts; a malt treatment step of keeping, in a second tank, a malt composition containing the barley malt at a temperature at which an enzyme contained in the barley malt acts, in parallel with the barley treatment step; and a mixing step of mixing the barley composition treated with the protease in the barley treatment step with the malt composition treated with the enzyme in the malt treatment step.

In this case, the barley treatment step and the malt treatment step are performed in parallel. That is, at least part of the malt treatment step is performed simultaneously with performing at least part of the barley treatment step. The first tank and the second tank are not particularly limited as long as the treatment of the barley with the protease and the treatment of the barley malt with the enzyme can each be independently carried out. For example, when equipment for producing a sparkling alcoholic beverage such as a bear or a low-malt beer is utilized, a mash tun can be used as the first tank and a mash kettle can be used as the second tank.

The barley may be treated with the protease at a first temperature, and the barley malt may be treated with the enzyme at a second temperature different from the first temperature. That is, for example, the barley composition is kept in the first tank at the first temperature in the barley treatment step, and the malt composition is kept in the second tank at the second temperature, that is lower than the first temperature, in the malt treatment step.

In this case, the temperature at which the barley composition is kept is not particularly limited as long as the protease acts, and may be, for example, 60 to 70° C., preferably 60 to 65° C. Further, the temperature at which the malt composition is kept is not particularly limited as long as the enzyme contained in the barley malt acts, and may be, for example, 45° C. or more and less than 60° C., preferably 45° C. or more and less than 55° C. It should be noted that the treatment of the barley with the protease and the treatment of the barley malt with the enzyme may be carried out at the same temperature.

It should be noted that, in the barley treatment step, the barley may be treated with the protease without being mixed with the barley malt, but the step is not limited thereto, and for example, the barley composition may contain the barley malt in a smaller amount than the amount of the barley. Likewise, in the malt treatment step, the barley malt may be treated with the enzyme without being mixed with the barley, but the step is not limited thereto, and for example, the malt composition may contain the barley in a smaller amount than the amount of the barley malt.

The barley composition subjected to the treatment with the protease is mixed with the malt composition subjected to the treatment with the enzyme contained in the barley malt in the mixing step. A method of mixing the barley composition with the malt composition is not particularly limited.

That is, for example, the barley composition may be mixed with the malt composition by transferring one of the barley composition and the malt composition from one of the first tank and the second tank to the other. Alternatively, the barley composition may be mixed with the malt composition in a third tank by transferring the barley composition and the malt composition from the first tank and the second tank to the third tank, respectively.

As described above, when the treatment of the barley and the treatment of the barley malt are independently performed in the first tank and the second tank, respectively, the barley is sufficiently treated with the protease to efficiently generate the hydrophobic polypeptide, and the barley malt is appropriately treated with the enzyme while reliably avoiding the effect of the protease on the barley malt.

The method of the present invention may also be, for example, a method of improving foam properties of a sparkling beverage to be produced using a raw material containing barley, the method including improving the foam properties of the sparkling beverage by treating the barley with a protease to increase the content of a hydrophobic polypeptide in the sparkling beverage by 0.05 g/L or more compared to the case where the barley is not treated with the protease.

In this case, in the method of the present invention, for example, the content of the hydrophobic polypeptide in the sparkling beverage can be increased by 0.05 g/L or more, and the NIBEM value of the sparkling beverage can also be increased by 10 or more.

Further, the content of the hydrophobic polypeptide in the sparkling beverage is preferably increased by 0.1 g/L or more, more preferably increased by 0.15 g/L or more, and particularly preferably increased by 0.2 g/L or more.

The method of the present invention may also be, for example, a method of producing a sparkling beverage using a raw material containing barley, the method including increasing a yield of a hydrophobic polypeptide per kg of the barley by 0.3 g or more by treating the barley with a protease.

That is, in this case, in the method of the present invention, the yield of the hydrophobic polypeptide per kg of the barley is increased by 0.3 g or more by treating the barley contained in the raw material with the protease compared to the case where the barley is not treated with the protease.

The method of the present invention may also be, for example, a method of improving foam properties of a sparkling beverage to be produced using a raw material containing barley, the method including improving the foam properties of the sparkling beverage by treating the barley with a protease to increase the yield of a hydrophobic polypeptide per kg of the barley by 0.3 g or more.

Further, the yield of the hydrophobic polypeptide per kg of the barley is preferably increased by 0.6 g/L or more, more preferably increased by 0.9 g/L or more, and particularly preferably increased by 1.2 g/L or more.

The method of the present invention may also be, for example, a method of producing a sparkling beverage using a raw material containing barley, the method including yielding a hydrophobic polypeptide in an amount of 6.6 g or more per kg of the barley by treating the barley with a protease.

When the method of the present invention is a method of producing a sparkling alcoholic beverage, in the method of the present invention, a pre-fermentation solution containing the hydrophobic polypeptide obtained in an amount of 6.6 g or more per kg of the barley is prepared, and alcoholic fermentation is performed by adding a yeast to the pre-fermentation solution.

The method of the present invention may be, for example, a method of improving foam properties of a sparkling beverage to be produced using a raw material containing barley, the method including improving the foam properties of the sparkling beverage by increasing the yield of a hydrophobic polypeptide per kg of the barley to 6.6 g or more by treating the barley with the protease.

Further, the yield of the hydrophobic polypeptide per kg of the barley is preferably 7.0 g or more, more preferably 7.1 g or more, particularly preferably 7.2 g or more.

FIG. 1 is a diagram illustrating major steps included in an example of a method of producing a sparkling alcoholic beverage according to the present invention. As illustrated in FIG. 1, the method of the present invention according to this example includes a pre-fermentation step 10 of preparing a pre-fermentation solution using a raw material containing barley, a fermentation step 20 of conducting alcoholic fermentation by adding a yeast to the pre-fermentation solution, and a post-fermentation step 30 of finally obtaining a sparkling alcoholic beverage.

In the pre-fermentation step 10, first, a raw material for the pre-fermentation solution is prepared. The raw material for the pre-fermentation solution contains a barley raw material. The barley raw material contains at least barley (non-germinated barley). Types of the barley are not particularly limited, and any one or more types thereof may be used. The barley without husk may also be used.

The raw material for the pre-fermentation solution may further contain barley malt (germinated barley). That is, in this case, the raw material for the pre-fermentation solution contains a barley raw material containing barley and barley malt. Types of the barley malt are not particularly limited, and anyone or more types thereof may be used. That is, barley malt conventionally used in the production of a sparkling alcoholic beverage such as a beer may be used as the barley malt. The barley malt may be prepared by impregnating barley with water in an appropriate amount to germinate the barley at an appropriate temperature in the presence of oxygen.

For example, the barley raw material may contain the barley in an amount of 1% by weight or more and 100% by weight or less and the barley malt in an amount of 0% by weight or more and 99% by weight or less, may contain the barley in an amount of 32% by weight or more and 100% by weight or less and the barley malt in an amount of 0% by weight or more and 68% by weight or less, may contain the barley in an amount of 51% by weight or more and 100% by weight or less and the barley malt in an amount of 0% by weight or more and 49% by weight or less, or may contain the barley in an amount of 76% by weight or more and 100% by weight or less and the barley malt in an amount of 0% by weight or more and 24% by weight or less.

A percentage of the barley raw material in the raw material for the pre-fermentation solution may be, for example, 1% by weight or more and 100% by weight or less, 20% by weight or more and 100% by weight or less, or 25% by weight or more and 95% by weight or less.

The raw material for the pre-fermentation solution may further contain hops. Types of the hops are not particularly limited, and any one or more types thereof may be used. The raw material for the pre-fermentation solution may also contain rice, naked barley, wheat, and wheat malt in addition to the barley raw material described above.

The raw material for the pre-fermentation solution may also contain nitrogen sources and carbon sources capable of being assimilated by a yeast. For example, degraded proteins and peptides derived from grains, degraded starch derived from grains, and yeast extracts may be used as the nitrogen sources and the carbon sources. Specifically, for example, degraded proteins and peptides derived from peas, soybeans, or corns, liquid saccharides (so-called liquid sugars) produced by degrading and purifying starch derived from grains such as corns, and proteins, peptides, and amino acids extracted from a yeast may be used.

In addition, in the method of the present invention, the barley contained in the raw material for the pre-fermentation solution is treated with the protease. That is, for example, the barley is treated with the protease so that the content of the hydrophobic polypeptide is 1.1 g/L or more in the sparkling alcoholic beverage to be produced by the method of the present invention. In this case, the barley may also be treated with the protease so that the content of the hydrophobic polypeptide is 1.2 g/L or more, or 1.3 g/L or more.

The barley is also treated with the protease so that the content of the hydrophobic polypeptide is increased by 0.05 g/L or more in the sparkling alcoholic beverage to be produced by the method of the present invention. In this case, the barley may also be treated with the protease so that the content of the hydrophobic polypeptide is increased by 0.1 g/L or more, 0.15 g/L or more, or 0.2 g/L or more.

The barley is also treated with the protease so that the yield of the hydrophobic polypeptide per kg of the barley is increased by 0.3 g or more. In this case, the barley may also be treated with the protease so that the yield of the hydrophobic polypeptide per kg of the barley is increased by 0.6 g/L or more, 0.9 g/L or more, or 1.2 g/L or more.

The barley is also treated with the protease so that the yield of the hydrophobic polypeptide per kg of the barley is increased to 6.6 g or more. In this case, the barley may also be treated with the protease so that the yield of the hydrophobic polypeptide per kg of the barley is increased to 7.0 g or more, 7.1 g or more, or 7.2 g or more.

Such treatment of the barley with the protease can be realized by appropriately selecting the type of the protease, and a condition for an enzyme reaction with the protease (e.g., a protease concentration, a reaction temperature, a reaction time, or a pH of a reaction solution).

The protease is not particularly limited as long as the protease acts on the barley, and any one or more types thereof may be used. That is, it is known that the protease is also present in the barley malt, but in the method of the present invention, a protease (exogenous protease) different from the protease in the barley malt (endogenous protease) may be added. That is, the protease to be allowed to act on the barley is added exogenously. Specifically, for example, a protease produced using a microorganism may be used. Examples of the microorganism to be used for producing the protease include Aspergillus oryzae and Streptomyces sp.

As the protease, there may be preferably used a protease that effectively increases the content of the hydrophobic polypeptide in the sparkling alcoholic beverage to be produced by the method of the present invention. That is, for example, a protease that increases the content of the hydrophobic polypeptide in the sparkling alcoholic beverage to 1.1 g/L or more may be used. In this case, a protease that increases the content of the hydrophobic polypeptide to 1.2 g/L or more or 1.3 g/L or more may also be used.

Further, for example, a protease that increases the content of the hydrophobic polypeptide in the sparkling alcoholic beverage by 0.05 g/L or more may be used. In this case, a protease that increases the content of the hydrophobic polypeptide by 0.1 g/L or more, 0.15 g/L or more, or 0.2 g/L or more may also be used.

Further, for example, a protease that increases the yield of the hydrophobic polypeptide per kg of the barley by 0.3 g or more may be used. In this case, a protease that increases the yield of the hydrophobic polypeptide per kg of the barley by 0.6 g/L or more, 0.9 g/L or more, or 1.2 g/L or more may also be used.

Further, for example, a protease that increases the yield of the hydrophobic polypeptide per kg of the barley to 6.6 g or more may be used. In this case, a protease that increases the yield of the hydrophobic polypeptide per kg of the barley to 7.0 g or more, 7.1 g or more, or 7.2 g or more may also be used.

For example, such protease may be selected as one that can accomplish the content and/or the yield of the hydrophobic polypeptide as described above from a plurality of types of proteases. That is, for example, the preferred protease as described above may be selected by treating barley contained in a raw material with the respective proteases to produce pre-fermentation solutions and/or sparkling alcoholic beverages, and comparing the yields of a hydrophobic polypeptide from the barley and/or the contents of the hydrophobic polypeptide in the sparkling alcoholic beverages.

The amount of the protease to be used is not particularly limited as long as the protease effectively acts on the barley, and may be, for example, 0.0025% by weight or more and 0.5% by weight or less with respect to the barley raw material. In this case, for example, the weight proportion of the protease with respect to the barley raw material may be 0.0025% by weight or more and less than 0.5% by weight, may be 0.01% by weight or more and less than 0.5% by weight, may be 0.01% by weight or more and 0.4% by weight or less, may be 0.025% by weight or more and 0.4% by weight or less, or may be 0.05% by weight or more and 0.4% by weight or less.

The treatment of the barley with the protease may be performed by mixing the barley and the protease with water and keeping the resulting mixture at a temperature suitable for the enzyme treatment with the protease (e.g., 30 to 70° C., preferably 30 to 65° C.) for a predetermined period of time (e.g., 1 to 120 minutes), as described above.

That is, when the barley and the barley malt are used as the barley raw material, for example, the treatment with the protease may be performed by mixing the barley, the barley malt, the protease, and water and keeping the resulting mixture at a predetermined temperature for a predetermined period of time.

Further, when the barley and the barley malt are used as the barley raw material, for example, the barley may also be treated with the protease without being mixed with the barley malt. That is, in this case, the treatment with the protease is performed by preparing a mixed solution containing the barley and the protease and not containing the barley malt and keeping the mixed solution at a predetermined temperature for a predetermined period of time. More specifically, for example, first, the barley, the protease, and the water may be loaded into a mash tun to perform the treatment with the protease, and then the barley malt may be loaded into the mash tun.

Further, for example, while barley malt and water are loaded into a mash tun to perform protein rest and saccharification, barley, a protease, and water are mixed to perform the treatment with the protease to prepare a barley composition in a vessel different from the mash tun, and the barley composition may also be loaded into the mash tun.

In this case, a time at which the barley composition is added to the barley malt may be any time before the start of fermentation to be described later. That is, for example, the barley composition may be mixed with the barley malt at a time after the protein rest of the barley malt and before saccharification, at any time during the saccharification, at a time after the saccharification and before filtration, at a time after the filtration and before boiling, or at a time after the boiling and before the start of the fermentation. Further, in any case, the protease may be inactivated at any time. That is, for example, the protease in the barley composition may be inactivated in advance by heating the barley composition before being added to the barley malt. Further, when the barley composition added to the barley malt is heated to a temperature at which the protease is inactivated, in a saccharification step or the like, the barley composition containing the protease that is not inactivated may also be added.

When the barley is treated with the protease without being mixed with the barley malt, it is possible to selectively treat the barley with the protease to efficiently generate the hydrophobic polypeptide, and to effectively avoid the effect of the protease on the barley malt. Further, in this case, the filtration efficiency of a raw material solution may also be enhanced.

Further, the pre-fermentation step 10 may include the barley treatment step, malt treatment step, and mixing step described above. In this case, in the pre-fermentation step 10, the barley treatment step using the first tank and the malt treatment step using the second tank are performed in parallel, and the barley composition treated in the barley treatment step and the malt composition treated in the malt treatment step are mixed to prepare the pre-fermentation solution in the mixing step.

Further, as described above, the treatment of the barley with the protease may be performed at the first temperature, and the treatment of the barley malt with the enzyme may be performed at the second temperature different from the first temperature. That is, for example, when the second temperature is lower than the first temperature, the barley composition is kept at the first temperature in the barley treatment step, the malt composition is kept at the second temperature in the malt treatment step, and the barley composition is mixed with the malt composition, and the resulting mixture is further kept at a temperature that is equal to or higher than the first temperature.

As described above, by independently performing the treatment of the barley and the treatment of the barley malt in the first tank and the second tank, respectively, it is possible to sufficiently treat the barley with an exogenous protease to efficiently generate the hydrophobic polypeptide, and to appropriately treat the barley malt with an endogenous enzyme while reliably avoiding the effect of the exogenous protease on the barley malt.

That is, for example, the treatment of the barley malt with the enzyme in the second tank is reliably performed in a relatively narrow range of temperatures (e.g., 45° C. or more and less than 60° C.) suitable for the so-called protein rest, whereas the treatment of the barley with the protease in the first tank may be performed in a broad range of temperatures (e.g., 30 to 70° C.) depending on desired properties to be imparted to the sparkling alcoholic beverage to be finally produced. The quality and amount of a component (e.g., a nitrogen-containing compound such as an amino acid and a peptide) to be extracted from the barley may be controlled depending on a temperature at which the barley is treated. In particular, in the temperature range of 30 to 70° C., the hydrophobic polypeptide can be efficiently generated from the barley, and the extraction of a flavoring component from the barley can be controlled in the preferable range.

Specifically, for example, a sparkling alcoholic beverage having a rich flavor can be produced by treating the barley with the protease at a relatively low temperature (e.g., around 50° C.). Further, for example, a sparkling alcoholic beverage that is easy to drink and has a refreshing flavor can be produced by treating the barley with the protease at a relatively high temperature (e.g., around 65° C.).

Therefore, a sparkling alcoholic beverage having both excellent foam properties and a desired flavor can be produced reliably and efficiently by independently performing the treatment of the barley and the treatment of the barley malt in the first tank and the second tank, respectively.

Further, the pre-fermentation solution can be prepared efficiently without causing, for example, any problem in the barley composition after the treatment and the malt composition after the treatment by performing the barley treatment step and the malt treatment step in parallel, and performing the mixing step as a continuous step subsequent to these steps.

That is, when the barley composition after the treatment of the barley with the protease is temporarily stored at low temperature, a problem such as contamination may occur in the barley composition. When the barley composition is concentrated in order to avoid a problem such as contamination, for example, a component for improving foam properties in the barley composition may precipitate through the concentration. To sufficiently cool the barley composition, equipment and time for cooling are required, which is problematic in terms of cost and efficiency. When the barley composition is boiled, a component for improving foam properties in the barley composition may precipitate.

In contrast, the problems as described above can be reliably avoided by performing the mixing of the barley composition with the malt composition as a continuous manipulation subsequent to the treatment of the barley with the protease and the treatment of the barley malt with the enzyme.

Further, as described above, by mixing the barley composition with the malt composition by transferring one of the barley composition and the malt composition from one of the first tank and the second tank to the other, it is possible to perform a mixing operation simply and efficiently using equipment for producing a sparkling alcoholic beverage such as a beer.

It should be noted that the treatment with the enzyme (e.g., treatment with protease, protein rest, or saccharification) in the pre-fermentation step 10 may be performed without boiling the raw material solution (so-called infusion method), or may also be performed by boiling part of the raw material solution (so-called decoction method).

As described above, the pre-fermentation solution containing the hydrophobic polypeptide obtained from the barley is prepared in the pre-fermentation step 10. That is, the pre-fermentation solution contains, for example, the hydrophobic polypeptide in an amount of 1.1 g/L or more. In this case, the pre-fermentation solution may also contain the hydrophobic polypeptide in an amount of 1.2 g/L or more or 1.3 g/L or more.

Further, the pre-fermentation solution contains, for example, the hydrophobic polypeptide whose content has been increased by 0.05 g/L or more by treating the barley with the protease. In this case, the pre-fermentation solution may also contain the hydrophobic polypeptide whose content has been increased by 0.1 g/L or more, 0.15 g/L or more, or 0.2 g/L or more.

Further, the pre-fermentation solution contains, for example, the hydrophobic polypeptide whose yield per kg of the barley has been increased by 0.3 g or more by treating the barley with the protease. In this case, the pre-fermentation solution may also contain the hydrophobic polypeptide whose yield per kg of the barley has been increased by 0.6 g/L or more, 0.9 g/L or more, or 1.2 g/L or more.

Further, the pre-fermentation solution contains, for example, the hydrophobic polypeptide obtained in an amount of 6.6 g or more per kg of the barley by treating the barley with the protease. In this case, the pre-fermentation solution may also contain the hydrophobic polypeptide obtained in an amount of 7.0 g or more, 7.1 g or more, or 7.2 g or more per kg of the barley.

In the fermentation step 20, alcoholic fermentation is performed by adding a yeast to the pre-fermentation solution prepared in the pre-fermentation step 10. That is, primary fermentation and secondary fermentation (so-called alcohol storage) are performed in the fermentation step 20.

Specifically, first, a fermentation solution is prepared by adding a yeast to a sterile pre-fermentation solution whose temperature has been adjusted to a predetermined range (e.g., a range of 0° C. to 20° C.) in advance. The yeast is not particularly limited as long as the yeast can conduct alcoholic fermentation, and any type thereof may be appropriately selected and used. That is, for example, a beer yeast such as a bottom-fermenting yeast or a top-fermenting yeast may be preferably used. The density of the yeast in the fermentation solution at the start of the fermentation may be appropriately adjusted to, for example, a range of 1×10⁶ cells/mL to 3×10⁷ cells/mL.

Then, the fermentation solution is kept at a predetermined temperature for a predetermined period of time to conduct primary fermentation. The temperature of the primary fermentation may be appropriately adjusted to, for example, a range of 6° C. to 25° C. In the primary fermentation, the yeast conducts a metabolic activity such as alcoholic fermentation while consuming the nitrogen sources and carbon sources contained in the pre-fermentation solution, and nutritional sources such as vitamins and minerals to be added, if necessary. As a result, in the fermentation solution, ethanol, carbon dioxide gas, and flavoring components (such as esters) are generated by the yeast.

The alcohol storage is conducted by further keeping the fermentation solution after the primary fermentation at a predetermined temperature for a predetermined period of time. The temperature of the alcohol storage may be appropriately adjusted to, for example, a range of −3° C. to 25° C. The alcohol storage can precipitate insoluble matter in the fermentation solution to remove turbidity, and can improve the flavor by maturation. Further, in the alcohol storage, carbon dioxide gas can further be dissolved in the fermentation solution.

Thus, in the fermentation step 20, a post-fermentation solution containing ethanol and flavoring components generated by the yeast can be obtained. The concentration of ethanol contained in the post-fermentation solution may be, for example, in a range of 1 to 20% by volume, preferably 1 to 10% by volume.

In the post-fermentation step 30, the sparkling alcoholic beverage is finally obtained by subjecting the post-fermentation solution prepared as described above to a predetermined treatment. As a treatment of the post-fermentation step 30, for example, the yeast contained in the post-fermentation solution can be removed by filtration of the post-fermentation solution.

Meanwhile, in the post-fermentation step 30, the post-fermentation solution is subjected to low-temperature sterilization by keeping the post-fermentation solution at a temperature of 60° C. or more for 1 minute or more, or high-temperature sterilization by keeping the post-fermentation solution at a higher temperature for a shorter period of time. Moreover, carbon dioxide gas may be injected into the post-fermentation solution.

Further, in the post-fermentation step 30, a spirit may be added to the post-fermentation solution. That is, in this case, a sparkling alcoholic beverage is obtained by mixing the spirit with the post-fermentation solution. As the spirit, there may be preferably used ones produced using grains as raw materials. That is, for example, a distilled spirit produced using, for example, barley, wheat, rice, soba, potato, sweet potato, corn, or sugarcane as the raw material may be used, and a distilled spirit produced using barley or wheat as the raw material may be particularly preferably used. The concentration of an alcohol contained in the spirit may be, for example, in a range of 20 to 90% by volume.

According to the method of the present invention, the sparkling alcoholic beverage having effectively improved foam properties is produced. Further, in the method of the present invention, the fermentation can be promoted by treating the barley with the protease. That is, for example, the amount of an extract contained in the pre-fermentation solution (wort) can be increased. That is, an extract acquisition rate can be improved. The number of days required for the fermentation can also be decreased. The growth of the yeast can also be promoted. Further, in the method of the present invention, through the treatment of the barley with the protease, an immature odor of the sparkling alcoholic beverage to be produced can be reduced effectively, and the contents of ethyl acetate and isoamyl acetate that are the preferred flavoring components (amounts generated by the yeast) can be increased effectively.

It should be noted that the method of the present invention is not limited to one including the step of conducting alcoholic fermentation. That is, for example, when the method of the present invention is a method of producing a sparkling non-alcoholic beverage, the sparkling non-alcoholic beverage can be produced by treating barley with a protease to prepare a barley composition and blending the barley composition with other components. Further, in this case, other components such as a malt composition prepared by treating barley malt with an enzyme and/or a hop extract may further be added. Further, a composition prepared by treating a mixture of barley and barley malt with a protease and any other enzyme may be used. In the method of the present invention, the concentration of an alcohol in the sparkling beverage may also be controlled depending on a condition for fermentation and treatment after the fermentation.

Subsequently, an improving agent for foam properties according to this embodiment (hereinafter, referred to as “improving agent of the present invention”) is described. The improving agent of the present invention is an improving agent for foam properties containing a hydrophobic polypeptide as an active ingredient. That is, as a result of independent extensive studies, the inventors of the present invention have newly found that the hydrophobic polypeptide described above can be used as an active ingredient for improving foam properties of a sparkling beverage.

The content of the hydrophobic polypeptide in the improving agent of the present invention is not particularly limited as long as an effect of improving foam properties is obtained.

The hydrophobic polypeptide may be obtained, for example, from the barley as described above. That is, in this case, the improving agent of the present invention contains the hydrophobic polypeptide obtained by treating the barley with the protease as the active ingredient.

The improving agent of the present invention may also contain the hydrophobic polypeptide fractionated in chromatography as described above as the active ingredient. That is, in this case, the hydrophobic polypeptide may be a polypeptide obtained by fractionating a fraction at the retention time corresponding to the hydrophobic polypeptide in the chromatography of the barley composition obtained by treating the barley with the protease. The improving agent of the present invention may be produced, for example, by treating the barley with the protease as described above.

The improving agent of the present invention may contain a pH adjuster, an antioxidant, a coloring agent, a aroma, and the like as long as its effect of improving foam properties is not impaired. Further, the improving agent of the present invention may be formed into products having various forms depending on the purposes. That is, the improving agent of the present invention may be formed into, for example, a dosage form such as a solution, a paste, a powder, a tablet, or a capsule.

Specifically, when the improving agent of the present invention is produced by keeping a solution containing barley and a protease at a predetermined temperature for a predetermined period of time, the improving agent may be a barley composition that is a solution after treatment with the protease, or may be a composition prepared by diluting or concentrating the solution. The improving agent of the present invention may also be a solid composition obtained by drying such liquid composition.

In addition, the method of the present invention may be, for example, a method of producing a sparkling beverage using the improving agent of the present invention as described above. In this case, in the method of the present invention, the improving agent of the present invention is added in a process of producing a sparkling beverage. That is, the method of the present invention may be, for example, a method of producing a sparkling beverage having improved foam properties by adding the improving agent of the present invention as part of a raw material.

The time at which the improving agent of the present invention is added is not particularly limited. That is, when the method of the present invention is the method of producing a sparkling alcoholic beverage as described above, the time may be any time before the start of fermentation. Specifically, the improving agent of the present invention may be added at a time after protein rest of barley malt and before saccharification, any time during the saccharification, a time after the saccharification and before filtration, a time after the filtration and before boiling, or a time after the boiling and before the start of fermentation.

According to the method of the present invention, the sparkling beverage having effectively improved foam properties is produced. That is, in the method of the present invention, the content of the hydrophobic polypeptide in the sparkling beverage is increased and the foam properties of the sparkling beverage are improved effectively by adding the improving agent of the present invention. It should be noted that, for example, even when the sparkling non-alcoholic beverage is produced without performing the fermentation, the foam properties (foam-forming property, foam-stability, foam adherence, and the like) are improved effectively by adding the improving agent of the present invention as part of the raw material and allowing the sparkling non-alcoholic beverage to contain carbon dioxide gas.

### EXAMPLES

### Example 1

### Production of Sparkling Alcoholic Beverage

A sparkling alcoholic beverage was produced by an infusion method using a raw material containing a barley raw material composed of barley and barley malt, hops, and a protease.

Any one type of the following seven types of proteases (hereinafter, referred to as “proteases P1 to P7”) was used as the protease. That is, a protease P1 (Orientase 10NL manufactured by HBI Enzymes Inc.), a protease P2 (Protin SD-PC10F manufactured by Amano Enzyme Inc.), a protease P3 (Umamizyme G manufactured by Amano Enzyme Inc.), a protease P4 (Trypsin 4.0T manufactured by HIGUCHI Inc.), a protease P5 (Sumizyme LP50D manufactured by Shin Nihon Chemical Co., Ltd.), a protease P6 (Sumizyme SP manufactured by Shin Nihon Chemical Co., Ltd.), or a protease P7 (Sumizyme ACP-G manufactured by Shin Nihon Chemical Co., Ltd.) was used.

It should be noted that those seven types of proteases were selected as preferred proteases each capable of contributing to the improvement of the foam properties of a sparkling alcoholic beverage in a preliminary test using sixteen types of proteases.

That is, the following nine types: Orientase 22BF (manufactured by HBI Enzymes Inc.), Orientase 10NL (manufactured by HBI Enzymes Inc.), Sumizyme Shochu (manufactured by Shin Nihon Chemical Co., Ltd.), Sumizyme P (manufactured by Shin Nihon Chemical Co., Ltd.), Sumizyme RPII (manufactured by Shin Nihon Chemical Co., Ltd.), Bioprase OP (manufactured by Nagase ChemteX Corporation), Aroase XA-10 (manufactured by Yakult Pharmaceutical Industry Co., Ltd.), Pantidase P (manufactured by Yakult Pharmaceutical Industry Co., Ltd.), and Neutrase 0.8L (manufactured by Novozymes) among the sixteen types of proteases were not employed as the result of screening in the preliminary test because they did not contribute to the improvement of the foam-stability of a sparkling alcoholic beverage.

First, the raw materials except the hops, that contained 830 g of the barley (77% by weight of the barley raw material), 250 g of the barley malt (23% by weight of the barley raw material), and 1.08 g of the protease (0.1% by weight with respect to the barley raw material), were placed in hot water at 50° C. to prepare a raw material solution. Then, the barley was treated with the protease and a protein rest was performed by keeping the raw material solution at 50° C. for 30 minutes.

Subsequently, saccharification was performed by keeping the raw material solution at 65° C. for 60 minutes. Then, the raw material solution was kept at 75° C. for 3 minutes, and subsequently filtrated to obtain a pre-fermentation solution. Further, the pre-fermentation solution was heated up to 100° C., 7 g of the hops were added, and the mixture was boiled. The pre-fermentation solution after the boiling was filtrated and then cooled.

A bottom-fermenting yeast was added to the cooled pre-fermentation solution to prepare a fermentation solution. Primary fermentation was performed by keeping the fermentation solution at a temperature of 10 to 13° C. for a predetermined period of time. Further, alcohol storage was performed by keeping the fermentation solution after the primary fermentation at a lower temperature for a predetermined period of time. The fermentation solution after the alcohol storage was filtrated to obtain a sparkling alcoholic beverage.

Further, a sparkling alcoholic beverage as a comparative control was produced in the same manner as above, except that no protease was used. Thus, eight types of the sparkling alcoholic beverages were produced.

[Evaluation of NIBEM Value]

NIBEM values of the eight types of sparkling alcoholic beverages produced as described above were measured. That is, first, each of the sparkling alcoholic beverages at 20° C. was poured into a standard glass from a draft dispenser using carbon dioxide gas. Then, the height of the formed foam was measured using a predetermined measurement apparatus (NIBEM-TPH manufactured by Haffmans), and a time required for reducing the height of the foam by 30 mm was evaluated as the NIBEM value (seconds).

[Reverse Phase Chromatography]

The sparkling alcoholic beverages produced using the protease P1, P5, or P7 among the eight types of sparkling alcoholic beverages and the sparkling alcoholic beverage produced using no protease were analyzed by reverse phase high performance liquid chromatography (HPLC).

That is, first, the sparkling alcoholic beverage diluted 2-fold with water was filtrated through a syringe filter (0.45 μm cellulose acetate). 400 μL of the filtrate was subjected to centrifugal filtration at 9,660 G for 1 hour using a centrifugal filter unit (Microcon-3 manufactured by Millipore), the resultant filtrate was discarded, 350 μL of water was added to a sample reservoir, and the mixture was similarly subjected to centrifugal filtration again to remove low molecular substances with molecular weights of 3,000 or less. The sample reservoir was reversed and centrifuged at 9,660 G for 5 minutes to collect a concentrated solution. Water was added to the concentrated solution to prepare 100 μL of a solution, which was used as a sample to be subjected to the analysis.

Then, 25 μL of the sample was analyzed using a column (mRP-C18, 4.6×50 mm, Agilent Technologies) containing porous C18 binding ultrapure 5 μm particulate silica as a filler.

A flow rate was set to 0.75 mL/minute, and the temperature was set to 80° C. 0.1% trifluoroacetic acid (TFA)/water was used as a buffer A, and 0.08% TFA/acetonitrile was used as a buffer B. A ratio of the buffer B was changed from 3% (0 to 5 minutes), to 3 to 30% (5 to 32 minutes), and 30 to 95% (32 to 40 minutes) over time. An absorbance was measured at a wavelength of 220 nm using a reference wavelength of 360 nm.

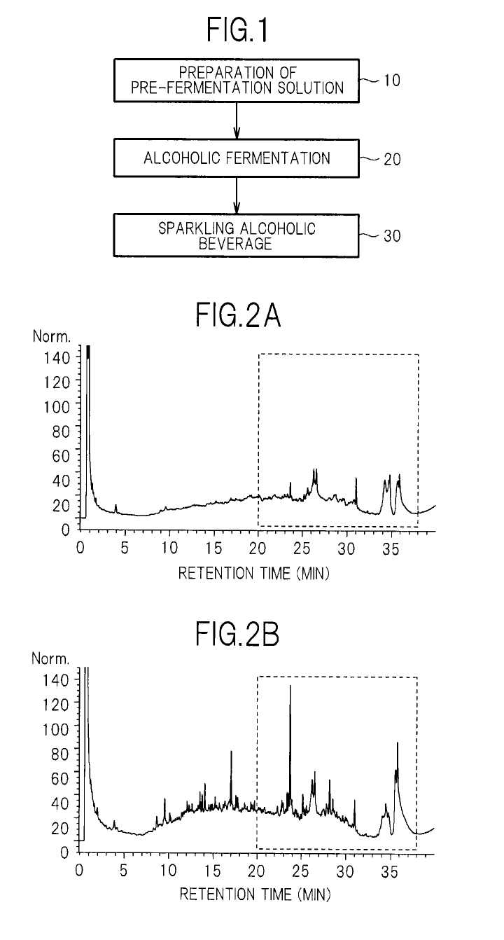

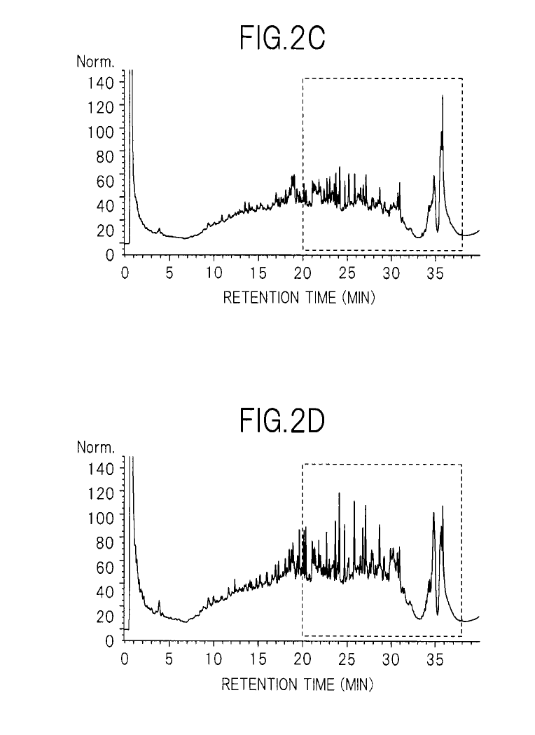

FIGS. 2A to 2D each illustrate an example of the resultant chromatograms. FIG. 2A illustrates a chromatogram obtained by analyzing the sparkling alcoholic beverage produced using the barley not treated with the protease. FIGS. 2B to 2D each illustrate a chromatogram obtained by analyzing the sparkling alcoholic beverage produced using the barley treated with the protease P1, P5, or P7.

As illustrated in FIGS. 2A to 2D, the heights of peaks of hydrophobic polypeptides (peaks boxed with a dotted line in the figures) detected in the retention time range of 20 to 38 minutes were increased by using the barley treated with the protease (FIGS. 2B to 2D) compared to the case of using the barley not treated with the protease (FIG. 2A). In particular, when the protease P5 was used (FIG. 2C) and when the protease P7 was used (FIG. 2D), the heights of the peaks of the hydrophobic polypeptides were increased remarkably.

[Quantification of Polypeptide]

A fraction corresponding to the retention time range of 20 to 38 minutes in the reverse phase HPLC described above was fractionated, and a hydrophobic polypeptide contained in the fraction was quantified. The polypeptide was quantified by the Lowry method using a commercially available kit (DC protein assay manufactured by Bio-Rad Laboratories).

That is, first, the sample ultrafiltrated as described above was diluted 2-fold with water, and 100 μL of the diluted sample was fractionated by reverse phase HPLC. The fraction fractionated as described above was placed in a 50-mL round-bottomed flask and dried and solidified with an evaporator (40° C., 20 bar). Then, 500 μL of a solution containing 0.1 M NaOH and 0.1% SDS was added to the solidified product, which was then dissolved by sonication for 30 minutes and pipetting. The solution was further diluted with the solution containing 0.1 M NaOH and 0.1% SDS so that the amount of the polypeptide was 1.48 mg/mL or less, and 50 μL of the diluted solution was dried and solidified with a centrifugal evaporator (40° C., 1.5 hours). 10 μL of ultrapure water was added to the solidified product, which was then dissolved therein.

50 μL of a reagent A′ (prepared by adding 20 μL of a reagent S to 1 mL of a reagent A) was added to the resulting solution, and dissolved by vortex mixing and sonication for 10 minutes. Further, 400 μL of a reagent B was added to the solution, and the whole was mixed with vortex. Then, a chromogenic reaction was performed at room temperature for 15 minutes.

200 μL of the sample after the reaction was transferred to a well plate, and an absorbance was measured at a wavelength of 750 nm using a plate reader. The content of the hydrophobic polypeptide in the sparkling alcoholic beverage was calculated based on the measured absorbance and a standard curve previously prepared.

It should be noted that the standard curve was prepared using bovine serum albumin (BSA). That is, first, a solution containing 1.48 mg/mL of BSA was diluted 0.2-, 0.4-, 0.6-, and 0.8-fold. The protein (BSA) in a mixture obtained by mixing 10 μL of each diluted BSA solution with 50 μL of a solution containing 0.1 M NaOH and 0.1% SDS was quantified in the same manner as in the above-mentioned case.

Further, a 40-kDa protein was quantified by a rocket immunoelectrophoresis method according to known literature (T. Kaneko et al; Breeding science, 49 (2), pp 69-74 1999 and J. Hejgaard et al; J. Inst. Brew. 83, 94-96 1977).

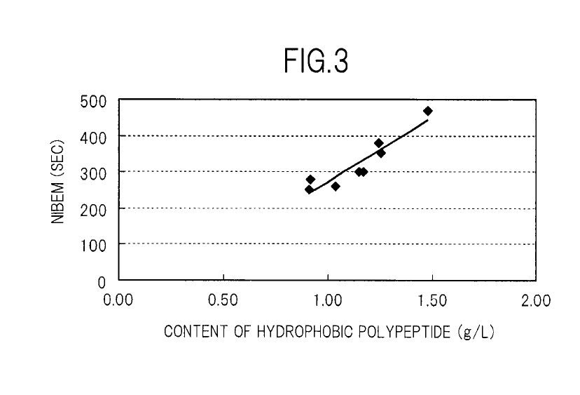

FIG. 3 illustrates the correlation between the content (g/L) of the hydrophobic polypeptide in the sparkling alcoholic beverage measured as described above and the NIBEM value (seconds) in the sparkling alcoholic beverage.

As illustrated in FIG. 3, the content of the hydrophobic polypeptide and the NIBEM value exhibited a satisfactory linear relation (correlation coefficient R=0.94). That is, for example, such a correlation that the NIBEM value was increased by about 20 seconds by increasing the content of the hydrophobic polypeptide in the sparkling alcoholic beverage by 0.05 g/L was obtained according to a linear approximate equation.

Therefore, it was conceivable that the increase of the content (concentration) of the hydrophobic polypeptide in the sparkling alcoholic beverage contributed to the improvement of the foam-stability (increase of NIBEM value) through the treatment of the barley with the protease.

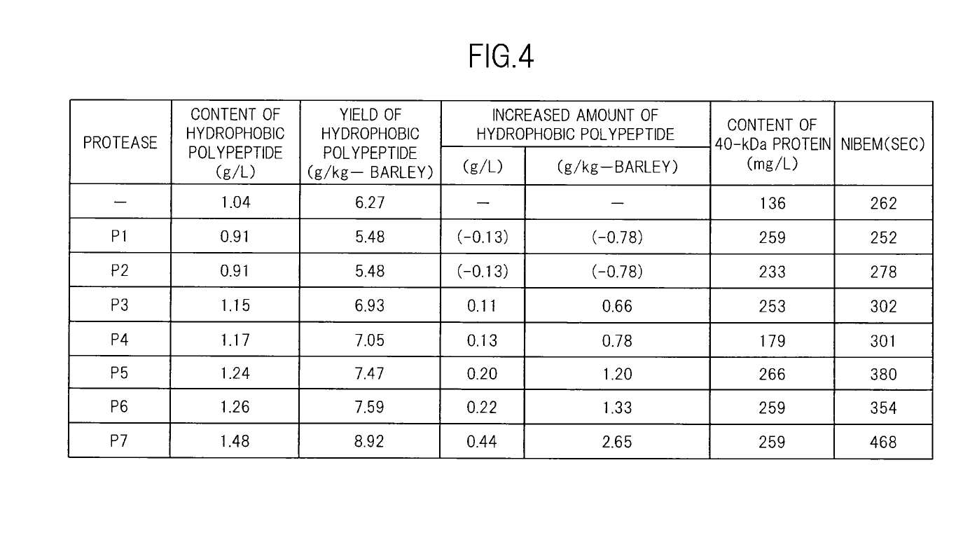

In FIG. 4, the type of protease (P1 to P7) used for the treatment of the barley, the content of the hydrophobic polypeptide (g/L), the yield of the hydrophobic polypeptide per kg of the barley (g/kg of barley), an increment in the content of the hydrophobic polypeptide by the use of the protease (g/L), an increment in the yield of the hydrophobic polypeptide by the use of the protease (g/kg of barley), the content of the 40-kDa protein, and the NIBEM value (seconds) are illustrated in relation to each other for each of the eight types of sparkling alcoholic beverages. It should be noted that the yield of the hydrophobic polypeptide per kg of the barley was calculated based on the content of the hydrophobic polypeptide in the sparkling alcoholic beverage (g/L), the weight of the barley used for the production of the sparkling alcoholic beverage (g), and the volume of the produced sparkling alcoholic beverage (L).

It is thought that there us barely any difference in the contents of the hydrophobic polypeptide and protein between in the pre-fermentation solution and in the sparkling alcoholic beverage produced using the pre-fermentation solution.

As illustrated in FIG. 4, the content of the hydrophobic polypeptide (g/L) was increased by 0.1 g/L or more compared to the content (1.04 g/L) when the barley was not treated with the protease and was increased to 1.1 g/L or more (1.15 to 1.48 g/L) by treating the barley with any one of the proteases P3 to P7. Meanwhile, when the barley was treated with the protease P1 or P2, the content of the hydrophobic polypeptide was decreased.

Further, the NIBEM value (seconds) was increased by 30 seconds or more compared to the value (262 seconds) when the barley was not treated with the protease, and was increased to 300 seconds or more (301 to 468 seconds) by treating the barley with any one of the proteases P3 to P7.

In particular, when any one of the proteases P5 to P7 was used, the content of the hydrophobic polypeptide was increased by 0.2 g/L or more, and the NIBEM value was also increased by 100 seconds or more and to 350 seconds or more (354 to 468 seconds).

Further, the yield of the hydrophobic polypeptide per kg of the barley (g/kg of barley) was increased by 0.6 (g/kg of barley) or more compared to the yield (6.27 (g/kg of barley)) when the barley was not treated with the protease, and was increased to 6.9 (g/kg of barley) or more (6.93 to 8.92 (g/kg of barley)) by treating the barley with any one of the proteases P3 to P7.

In particular, when any one of the proteases P5 to P7 was used, the yield of the hydrophobic polypeptide was increased by 1.0 (g/kg of barley) or more and to 7.4 (g/kg of barley) or more (7.47 to 8.92 (g/kg of barley)).

Meanwhile, the content of the 40-kDa protein in the sparkling alcoholic beverage (mg/L) was, for example, 259 mg/L in any one of the cases where the NIBEM value was 252 seconds (protease P2 was used), where the NIBEM value was 354 seconds (protease P6 was used), and where the NIBEM value was 468 seconds (protease P7 was used). That is, a clear correlation such as the one in the case of the hydrophobic polypeptide described above was not observed between the content of the 40-kDa protein and the NIBEM value.

Further, sensory evaluations for each of the eight types of sparkling alcoholic beverages were carried out by skilled panelists. As a result, comprehensive evaluation was obtained that aroma and taste were excellent, particularly in the sparkling alcoholic beverages produced by treating the barley with any one of the proteases P5 to P7.

[Analysis of Amino Acid Composition]

Six types, i.e., the sparkling alcoholic beverages produced using the protease P1, P4, P5, P6 or P7 and the sparkling alcoholic beverage produced without using the protease, among the eight types of sparkling alcoholic beverages, were analyzed by reverse phase HPLC in the same manner as in “Reverse phase chromatography” described above.

In addition, fractions corresponding to the retention time range of 20 to 38 minutes in the reverse phase HPLC were fractionated in the same manner as in “Quantification of polypeptide” described above. Then, the fractionated fraction was dried and solidified with an evaporator. The solidified product was dissolved in 1 mL of 20% ethanol, and 40 to 200 μL of the solution was used as a sample for the analysis of an amino acid composition.

The sample was placed in a test tube, and dried and solidified under reduced pressure. 200 μL of 6 mol/L hydrochloric acid was added to the solidified product. A gas phase in the test tube was replaced with nitrogen, and the test tube was sealed under reduced pressure. Hydrolysis was performed by heating the test tube at 110° C. for 22 hours. Subsequently, the solution in the test tube was dried and solidified under reduced pressure. 200 μL of 0.02 mol/L hydrochloric acid was added to the solidified product, which was then dissolved. The resulting solution was filtrated through a 0.22 μm centrifugal filtration unit to obtain a sample solution.

25 μL of the sample solution were analyzed using an amino acid analyzer (L-8800 A Model manufactured by Hitachi, Ltd.). A biological fluid analytical condition/ninhydrin method was employed as a measurement condition. A detection wavelength for proline was set to 440 nm, and a detection wavelength for amino acids other than proline was set to 570 nm.

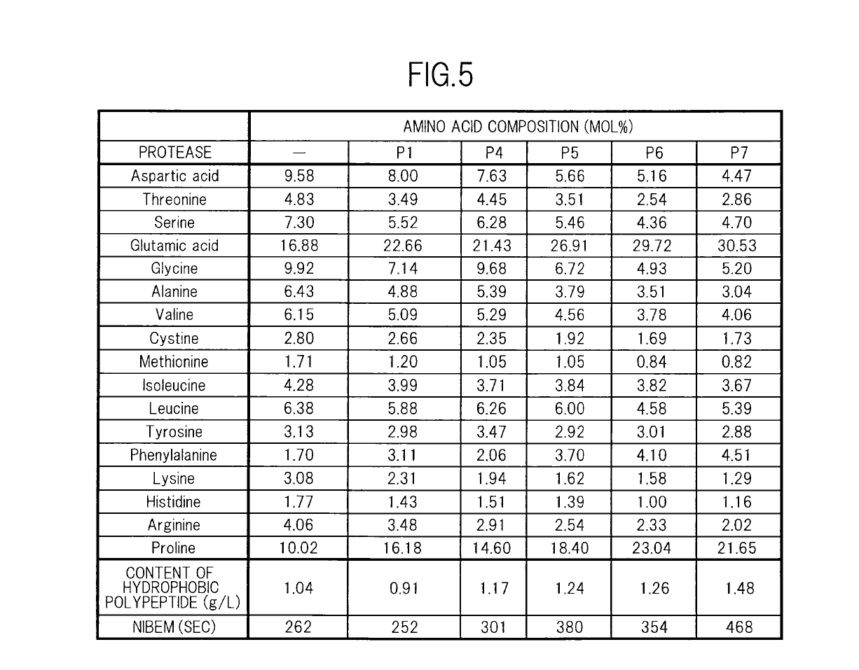

FIG. 5 illustrates results of analyzing the amino acid composition for each of the six types of sparkling alcoholic beverages. That is, FIG. 5 illustrates the type of the protease used for producing each sparkling alcoholic beverage and a content rate (mol %) of each amino acid. The content of the hydrophobic polypeptide (g/L) and the NIBEM value (seconds) illustrated in FIG. 4 as described above are also illustrated again as references.

As illustrated in FIG. 5, the proline content (14.60 to 23.04 mol %) was particularly obviously high in the hydrophobic polypeptides fractionated from the five types of sparkling alcoholic beverages produced using the protease compared to the content (10.02 mol %) in the sparkling alcoholic beverage produced using no protease.

In this regard, however, in the sparkling alcoholic beverage using the protease P2, as illustrated in FIG. 4, the content of the hydrophobic polypeptide was as low as 0.91 g/L, and the NIBEM value was as small as 252 seconds.

Therefore, the four types of sparkling alcoholic beverages produced using any one of the proteases P4 to P7 and exhibiting high NIBEM values among the six types illustrated in FIG. 5 achieved the extremely excellent foam-stability probably because the content of the hydrophobic polypeptide was 1.1 g/L or more and the proline content of the hydrophobic polypeptide was 13.5 mol % or more (in other words, by containing the hydrophobic polypeptide having a proline content of 13.5 mol % or more in an amount of 1.1 g/L or more).

[Gel Filtration Chromatography]

The sparkling alcoholic beverages produced using the protease P1, P5, or P7 and the sparkling alcoholic beverage produced using no protease, among the eight types of sparkling alcoholic beverages were analyzed by gel filtration chromatography.

That is, 100 μL each of the sparkling alcoholic beverages was analyzed using a gel filtration column (Superdex 75 10/300GL, manufactured by GE Healthcare Japan). A flow rate was set to 0.5 mL/minute. A 50 mM phosphate buffer (pH 7.0, 150 mM NaCl) was used as a developing solution. In addition, an absorbance was measured at a wavelength of 215 nm.

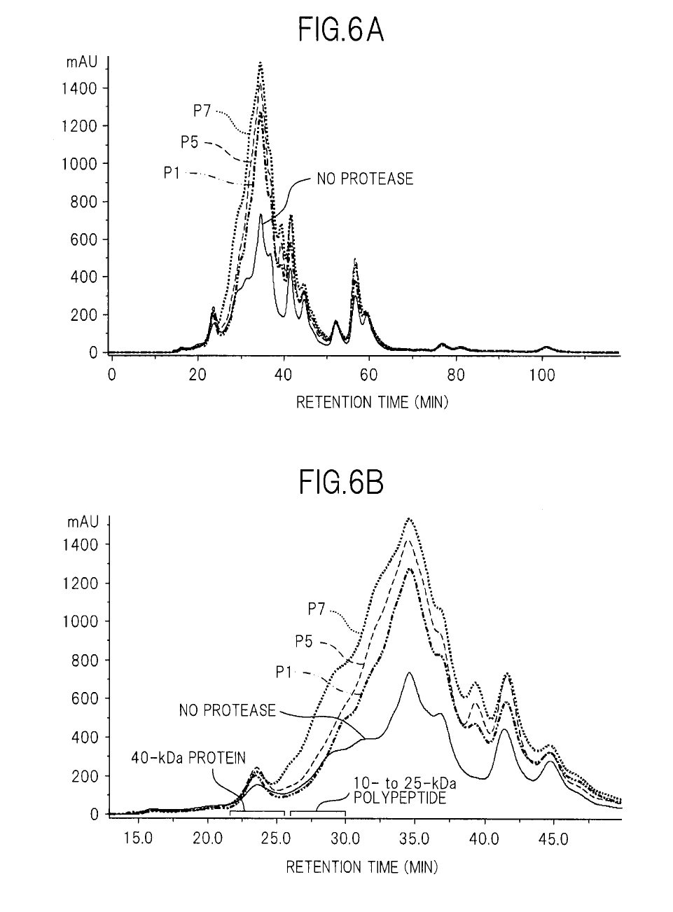

FIGS. 6A and 6B each illustrate an example of the resultant chromatograms. The chromatogram illustrated in FIG. 6A is partially magnified in FIG. 6B. In FIGS. 6A and 6B, the result of the analysis of the sparkling alcoholic beverage produced using the barley not treated with the protease is represented by a solid line (“No protease” in the figure), the result of the analysis of the sparkling alcoholic beverage produced using the barley treated with the protease P1 is represented by a two-point dotted line (“P1” in the figure), the result of the analysis of the sparkling alcoholic beverage produced using the barley treated with the protease P5 is represented by a long dotted line (“P5” in the figure), and the result of the analysis of the sparkling alcoholic beverage produced using the barley treated with the protease P7 is represented by a dotted line (“P7” in the figure).

As illustrated in FIGS. 6A and 6B, the heights of the peaks detected in the retention time range of 26 to 30 minutes corresponding to molecular weights of 10 to 25 kDa were increased by the use of the barley treated with the protease (“P1,” “P5,” and “P7” in the figures) compared to the case of using the barley not treated with the protease (“No protease” in the figures). In particular, the height of the peaks of polypeptides having molecular weights of 10 to 25 kDa was remarkably increased when the protease P5 or P7 was used.

Further, the peak of a polypeptide having a molecular weight of 10 to 15 kDa and the peak of a polypeptide having a molecular weight of 15 to 25 kDa were detected in the retention time range of 26 to 30 minutes. The heights of the two peaks were remarkably increased when the barley treated with the protease was used, and particularly when the barley treated with the protease P5 or P7 was used.

Further, the peak of the 40-kDa protein was detected around a retention time of 24 minutes. The height of the peak of the 40-kDa protein was also increased when the barley treated with the protease was used. However, no clear correlation was observed, as with the case of the quantitative value of the 40-kDa protein as described above.

It should be noted that the molecular weights were estimated by using a Gel Filtration Calibration Kit LMW (for low molecular weight, manufactured by GE Healthcare Ltd.) through comparison with the retention times of aprotinin (MW 6,500), ribonuclease A (MW 13,700), carbonic anhydrase (MW 29,000), ovalbumin (MW 43,000), and conalbumin (MW 75,000).

### Example 2

### Production of Pre-Fermentation Solution

A pre-fermentation solution was prepared by the infusion method using a raw material containing a barley raw material composed of barley and barley malt, hops, and a protease. The protease P5 used in Example 1 described above was used as the protease.

Two types of pre-fermentation solutions, i.e., a pre-fermentation solution containing the protease (0.1% by weight with respect to the barley raw material) and a pre-fermentation solution using no protease as a comparative control, were produced in the same manner as in Example 1.

[Gel Filtration Chromatography]

The two types of pre-fermentation solutions produced as described above were analyzed by gel filtration chromatography in the same manner as in Example 1 above. That is, 100 μL each of the pre-fermentation solutions were analyzed using a gel filtration column (Superdex 75 10/300GL, manufactured by GE Healthcare Japan). The flow rate was set to 0.5 mL/minute. A 50 mM phosphate buffer (pH 7.0, 0.150 mM NaCl) was used as the developing solution. In addition, an absorbance was measured at a wavelength of 215 nm.

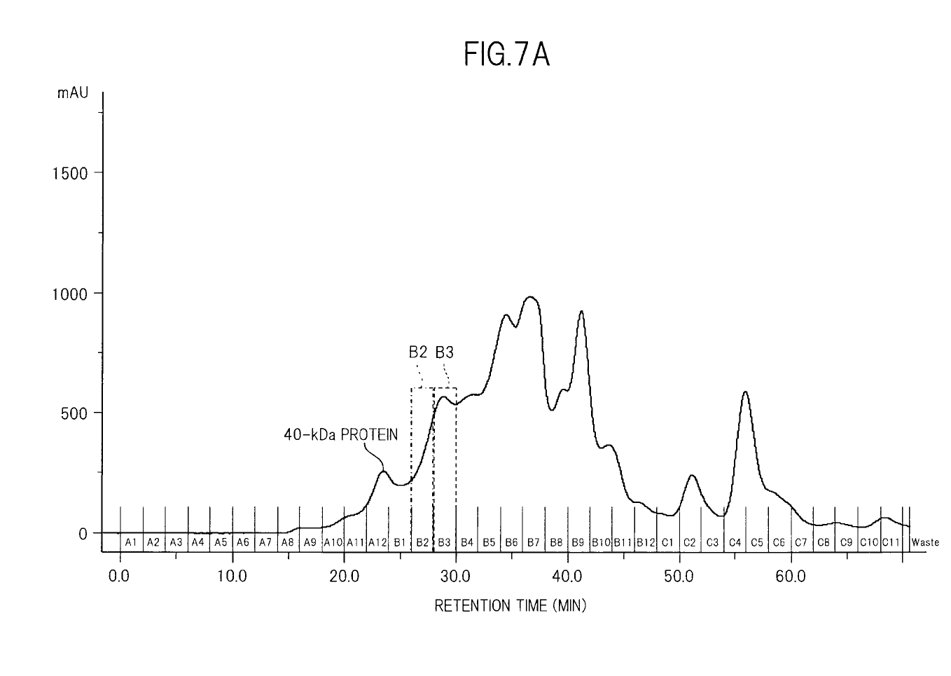

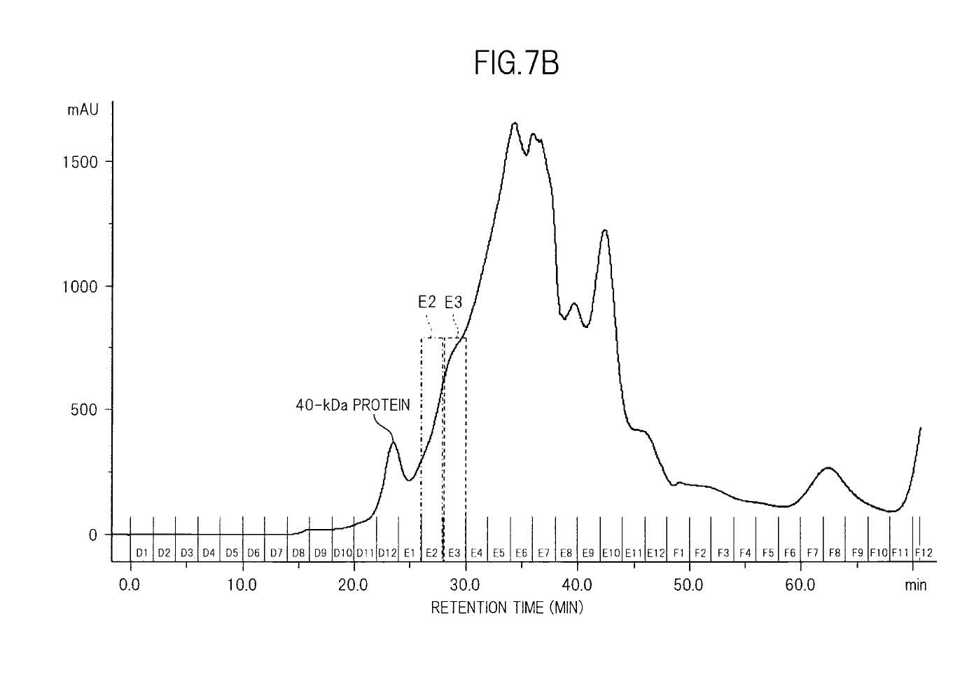

FIGS. 7A and 7B each illustrate an example of the resultant chromatograms. FIG. 7A illustrates the result of the analysis of the pre-fermentation solution produced using the barley not treated with the protease, and FIG. 7B illustrates the result of the analysis of the pre-fermentation solution produced using the barley treated with the protease P5.

As illustrated in FIGS. 7A and 7B, the height of a peak detected in the retention time range of 26 to 30 minutes corresponding to molecular weights of 10 to 25 kDa was remarkably increased by the use of the barley treated with the protease P5 (FIG. 7B) compared to the case of using the barley not treated with the protease (FIG. 7A).

Further, the peak of a polypeptide having a molecular weight of 10 to 15 kDa and the peak of a polypeptide having a molecular weight of 15 to 25 kDa were detected in the retention time range of 26 to 30 minutes. The heights of the two peaks were remarkably increased when the barley treated with the protease P5 was used.

Further, the peak of the 40-kDa protein was detected around a retention time of 24 minutes. The height of the peak of the 40-kDa protein was also increased when the protease P5 was used.

[Reverse Phase Chromatography]

A fraction corresponding to the retention time range of 26 to 28 minutes (hereinafter, referred to as “first fraction”) and a fraction corresponding to the retention time range of 28 to 30 minutes (hereinafter, referred to as “second fraction”) were each fractionated in the gel filtration chromatography described above. That is, the first fraction in the range of “B2” and the second fraction in the range of “B3” illustrated in FIG. 7A were fractionated from the pre-fermentation solution produced using the barley not treated with the protease. Further, the first fraction in the range of “E2” and the second fraction in the range of “E3” illustrated in FIG. 7B were fractionated from the pre-fermentation solution produced using the barley treated with the protease P5.

In addition, 500 μL of each fraction was subjected to centrifugal concentration to 100 μL or less using a centrifugal ultrafiltration filter at 9,660 G. The resultant was adjusted to 100 μL with a 50 mM phosphate buffer (pH 7.0, 150 mM NaCl), and analyzed by reverse phase HPLC in the same manner as in Example 1 above. That is, 50 μL of each sample was analyzed using a column (mRP-C18, 4.6×50 mm, Agilent Technologies) containing porous C18 binding ultrapure 5 μm particulate silica as a filler.

The flow rate was set to 0.75 mL/minute, and the temperature was set to 80° C. 0.1% trifluoroacetic acid (TFA)/water was used as a buffer A, and 0.08% TFA/acetonitrile was used as a buffer B. A ratio of the buffer B was changed from 3% (0 to 5 minutes), to 3 to 30% (5 to 32 minutes), and 30 to 95% (32 to 40 minutes) over time. An absorbance was measured at a wavelength of 220 nm using a reference wavelength of 360 nm.

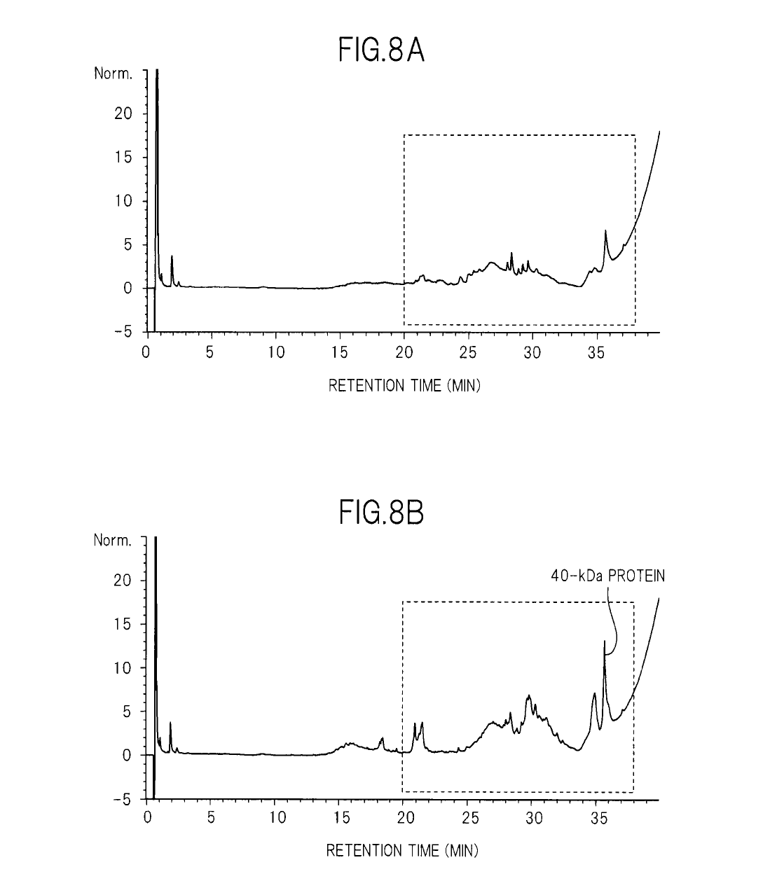

FIGS. 8A and 8B each illustrate an example of chromatograms obtained by the analysis of the first fraction. FIG. 8A illustrates a chromatogram obtained from the analysis of the first fraction of the pre-fermentation solution produced using the barley not treated with the protease (“B2” in FIG. 7A). FIG. 8B illustrates a chromatogram obtained from the analysis of the first fraction of the pre-fermentation solution produced using the barley treated with the protease P5 (“E2” in FIG. 7B).

As illustrated in FIGS. 8A and 8B, most of the peaks of the polypeptides contained in the first fraction were detected in the retention time range of 20 to 38 minutes, as with the case of the hydrophobic polypeptides detected in Example 1 above (see FIGS. 2A to 2D).

In addition, the heights of the peaks of the hydrophobic polypeptides contained in the first fraction were remarkably increased by the use of the barley treated with the protease P5 (FIG. 8B) compared to the case of using the barley not treated with the protease (FIG. 8A).

From the results, it was conceivable that the hydrophobic polypeptides thought to contribute to the increase of the NIBEM value in Example 1 above included the polypeptides contained in the first fraction. It should be noted that, as illustrated in FIG. 8B, the 40-kDa protein was mixed in the first fraction (“40-kDa protein” in the figure), but most of the hydrophobic polypeptides increased by treating the barley with the protease P5 were polypeptides other than the 40-kDa protein.

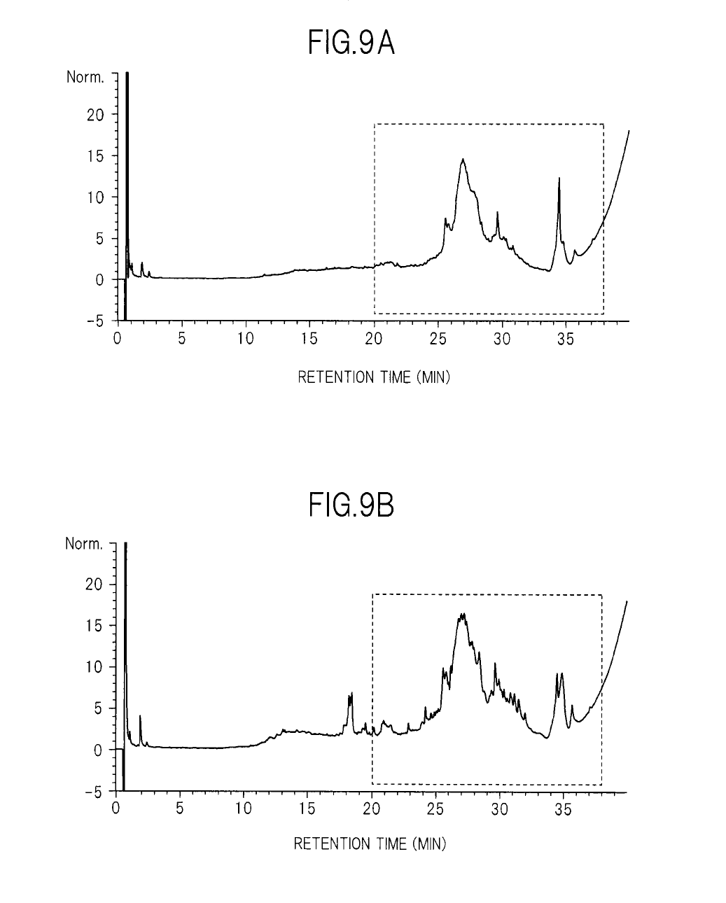

FIGS. 9A and 9B each illustrate an example of chromatograms obtained by the analysis of the second fraction. FIG. 9A illustrates a chromatogram obtained from the analysis of the second fraction of the pre-fermentation solution produced using the barley not treated with the protease (“B3” in FIG. 7A). FIG. 9B illustrates a chromatogram obtained from the analysis of the second fraction of the pre-fermentation solution produced using the barley treated with the protease P5 (“E3” in FIG. 7B).

As illustrated in FIGS. 9A and 9B, most of the peaks of the polypeptides contained in the second fraction were detected in the retention time range of 20 to 38 minutes as with the case of the hydrophobic polypeptides detected in Example 1 above (see FIGS. 2A to 2D).

In addition, the heights of the peaks of the hydrophobic polypeptides contained in the second fraction were remarkably increased by the use of the barley treated with the protease P5 (FIG. 9B) compared to the case of using the barley not treated with the protease (FIG. 9A).

From the results, it was conceivable that the hydrophobic polypeptide thought to contribute to the increase of the NIBEM value in Example 1 above included the polypeptide contained in the second fraction. Therefore, it was conceivable that the hydrophobic polypeptide, the yield of which was increased from the barley treated with the protease, included the polypeptide having a molecular weight of 10 to 25 kDa measured by the gel filtration chromatography.

### Example 3

### Treatment of Barley Extract with Protease

Barley was extracted with hot water by adding 1 L of the hot water at 55° C. to 200 g of the barley and keeping the mixture at 55° C. for 2 hours. Subsequently, the mixture was filtrated using No. 2 filter paper, 1 L of hot water at 55° C. was added to the residue, and the mixture was further filtrated to collect 1.2 L of a filtrate containing a barley extract.

In addition, the barley extract was treated with the protease P5 by adding 25 mg of the protease P5 used in Example 1 above to a part (0.6 L) of the filtrate and keeping the mixture at 55° C. for 1 hour. Subsequently, the protease P5 was inactivated by keeping the solution at 105° C. for 1 hour. Then, the solution was centrifuged at 12,000 G for 20 minutes, and a supernatant was collected. Further, the supernatant was subjected to precipitation with ammonium sulfate to obtain a 0 to 40% saturated ammonium sulfate precipitate and a 40 to 75% saturated ammonium sulfate precipitate.

Further, as a comparative control, another part (0.6 L) of the above-mentioned filtrate was kept at 105° C. for 1 hour without carrying out the treatment with the protease. Then, the solution was centrifuged at 12,000 G for 20 minutes, and a supernatant was collected. In addition, the supernatant was subjected to precipitation with ammonium sulfate to obtain a 0 to 40% saturated ammonium sulfate precipitate and a 40 to 75% saturated ammonium sulfate precipitate.

[Gel Filtration Chromatography]

The four types of ammonium sulfate precipitates obtained as described above were analyzed by gel filtration chromatography in the same manner as in Example 1 above. That is, 100 μL of each the ammonium sulfate precipitates was analyzed using a gel filtration column (Superdex 75 10/300GL, manufactured by GE Healthcare Japan).

The flow rate was set to 0.5 mL/minute. A 50 mM phosphate buffer (pH 7.0, 150 mM NaCl) was used as the developing solution. In addition, an absorbance was measured at a wavelength of 215 nm.

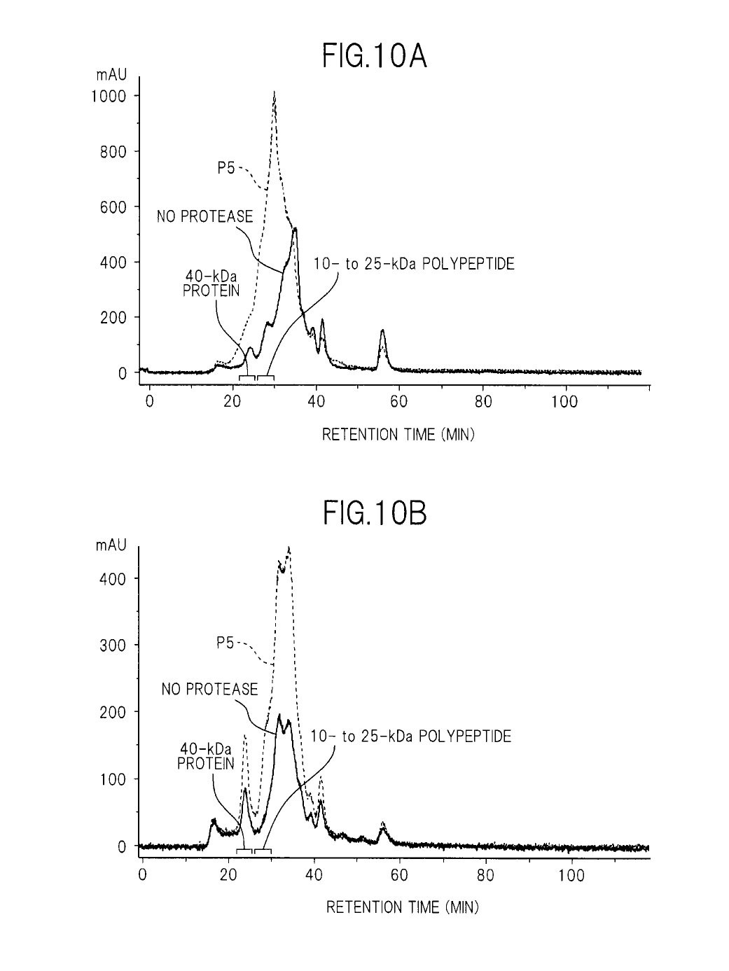

FIGS. 10A and 10B each illustrate an example of the resultant chromatograms. FIG. 10A illustrates the results of the analysis of the 0 to 40% saturated ammonium sulfate precipitates, and FIG. 10B illustrates the results of the analysis of the 40 to 75% saturated ammonium sulfate precipitates. In FIGS. 10A and 10B, the result of the analysis of the ammonium sulfate precipitate containing the barley extract not treated with the protease (“No protease” in the figure) is represented by a solid line and the result of the analysis of the ammonium sulfate precipitate containing the barley extract treated with the protease P5 (“P5” in the figure) is represented by a dotted line.

As illustrated in FIG. 10A, the heights of the peaks detected in the retention time range of 26 to 30 minutes corresponding to molecular weights of 10 to 25 kDa were remarkably increased by treating the barley extract with the protease (“P5” in the figure) compared to the case where the barley extract was not treated with the protease (“No protease” in the figure) in the 0 to 40% saturated ammonium sulfate precipitate.

Further, the peak of the 40-kDa protein was detected around a retention time of 24 minutes, and the height of the peak of the 40-kDa protein was also increased by treating the barley extract with the protease P5.

Meanwhile, as illustrated in FIG. 10B, the heights of the peaks detected in the retention time range of 26 to 30 minutes corresponding to molecular weights of 10 to 25 kDa were also remarkably increased by treating the barley extract with the protease (“P5” in the figure) compared to the case where the barley extract was not treated with the protease (“No protease” in the figure) in the 40 to 75% saturated ammonium sulfate precipitate. In this regard, however, the heights of the peaks of the polypeptides having molecular weights of 10 to 25 kDa were remarkably decreased compared to those of the 0 to 40% saturated ammonium sulfate precipitate illustrated in FIG. 10A.

Further, the peak of the 40-kDa protein was detected around a retention time of 24 minutes, and the height of the peak of the 40-kDa protein was also increased by treating the barley extract with the protease P5. In addition, the height of the peak of the 40-kDa protein was also decreased compared to that of the 0 to 40% saturated ammonium sulfate precipitate illustrated in FIG. 10A, but the degree of the decrease was smaller than those in the polypeptides having molecular weights of 10 to 25 kDa described above.

It should be noted that it is known that LTP1, known as a protein that improves the foam properties of beer, as with the 40-kDa protein, is included not in the 0 to 40% saturated ammonium sulfate precipitate but in the 40 to 75% saturated ammonium sulfate precipitate based on the principle of the ammonium sulfate precipitation (for example, known literature: Kresten Lindorff-Larsen et al., The Journal of Biological Chemistry, 276, 33547-33553 (2001), known literature: Stanislava Gorjanovic et al., J. Inst. Brew. 111(2), 99-104, 2005).

[Evaluation of NIBEM Value]

The four types of ammonium sulfate precipitates described above were evaluated for effects on the NIBEM value of beer. That is, 30 mL of any one of the ammonium sulfate precipitates was added to 633 mL of beer having an NIBEM value of 274 seconds. In addition, the NIBEM value of the beer after the addition was measured in the same manner as in Example 1 above.

As a result, the NIBEM value of the beer was increased by 19.7 seconds by adding the 0 to 40% saturated ammonium sulfate precipitate containing the barley extract treated with the protease P5 (“P5” illustrated in FIG. 10A) to the beer. Meanwhile, the NIBEM value of the beer was decreased by 16.8 seconds by adding the 0 to 40% saturated ammonium sulfate precipitate containing the barley extract not treated with the protease (“No protease” illustrated in FIG. 10A) to the beer.

Further, the NIBEM value of the beer was decreased by 11.3 seconds and 18.8 seconds when the 40 to 75% saturated ammonium sulfate precipitate containing the barley extract treated with the protease P5 (“P5” illustrated in FIG. 10B) was added to the beer and when the 40 to 75% saturated ammonium sulfate precipitate containing the barley extract not treated with the protease (“No protease” illustrated in FIG. 10B) was added to the beer, respectively.

That is, only the 0 to 40% saturated ammonium sulfate precipitate containing the barley extract treated with the protease P5 (“P5” illustrated in FIG. 10A) remarkably improved the foam-stability of the beer. As described above, LTP1 was not contained in the 0 to 40% saturated ammonium sulfate precipitate, and the content of the 40-kDa protein in the 40 to 75% saturated ammonium sulfate precipitate was not largely different from that in the 0 to 40% saturated ammonium sulfate precipitate. Thus, it was conceivable that the polypeptide having a molecular weight of 10 to 25 kDa, the content of which was remarkably increased by the treatment with the protease P5, contributed to the effect of improving the foam-stability specifically for the 0 to 40% saturated ammonium sulfate precipitate containing the barley extract treated with the protease P5.

### Example 4

### Production of Pre-Fermentation Solution

A pre-fermentation solution was prepared by the infusion method using a raw material containing a barley raw material composed of barley and barley malt, hops, and a protease. The protease P5 used in Example 1 described above was used as the protease.

Two types of pre-fermentation solutions, i.e., a pre-fermentation solution containing the protease (0.01% by weight with respect to the barley raw material) and a pre-fermentation solution using no protease as a comparative control, were produced in the same manner as in Example 1. In addition, the pre-fermentation solutions were each subjected to precipitation with ammonium sulfate to yield a 25 to 40% saturated ammonium sulfate precipitate.

[Cation Exchange Chromatography]

The ammonium sulfate precipitate obtained as described above was analyzed by cation exchange chromatography. That is, 5 mL of the ammonium sulfate precipitate was analyzed using a cation exchange column (HiTrap SP 5 mL HP, manufactured by GE Healthcare Japan).

The flow rate was set to 2 mL/minute, a 50 mM citrate buffer (pH 4.2) was used as a buffer A, and a 50 mM citrate buffer (pH 6.2) was used as a buffer B. In addition, an absorbance was measured at each of wavelengths of 215 nm and 280 nm.

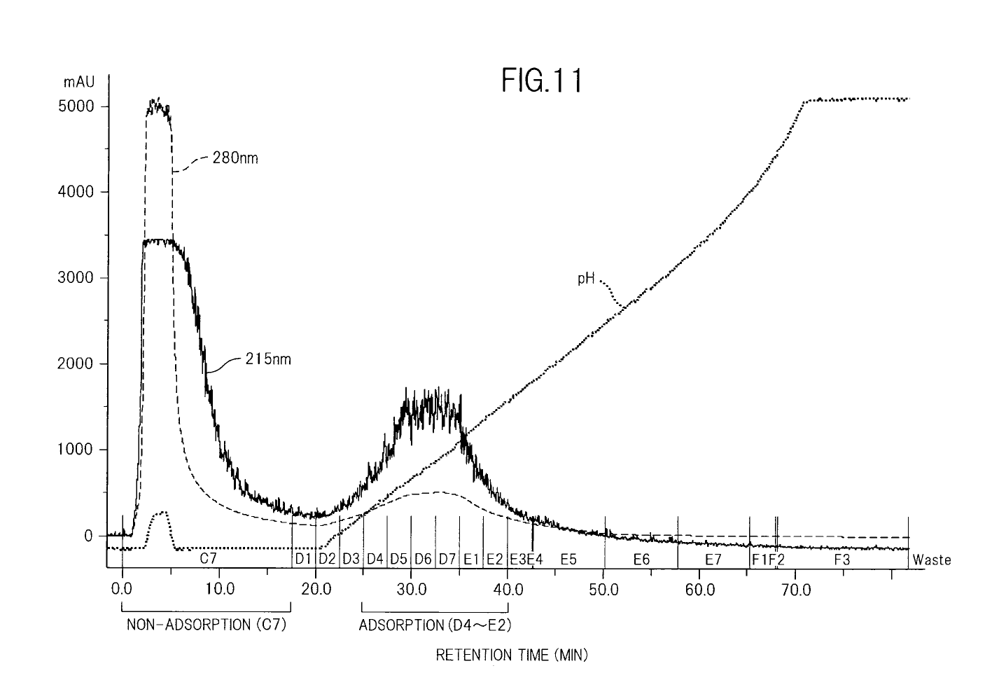

FIG. 11 illustrates an example of the resultant chromatogram. In FIG. 11, a polypeptide detected at a wavelength of 215 nm is represented by a solid line (“215 nm” in the figure), a polypeptide detected at a wavelength of 280 nm is represented by a long dotted line (“280 nm” in the figure), and the change of pH is represented by a dotted line (“pH” in the figure).

As illustrated in FIG. 11, a non-adsorbed fraction (whose peak was detected in the range of “Non-adsorption (C7)” in the figure) and an adsorbed fraction (whose peak was detected in the range of “Adsorption (D4 to E2)” in the figure) were included in the polypeptides contained in the ammonium sulfate precipitate obtained from the pre-fermentation solution. The isoelectric point (pI) of the polypeptide included in the adsorbed fraction seemed to be 4.9 to 5.4. It should be noted that the isoelectric point of LTP1 is known to be larger than 9 (known literature: Stanislava Gorjanovic et al., J. Inst. Brew. 111 (2), 99-104, 2005). That is, the polypeptide having an isoelectric point of 4.9 to 5.4 that was different from at least LTP1 was included in the ammonium sulfate precipitate.

[Evaluation of NIBEM Value]

The polypeptide included in the non-adsorbed fraction and the polypeptide included in the adsorbed fraction described above were evaluated for their effects on the NIBEM value of beer. That is, first, the non-adsorbed fraction and the adsorbed fraction were each fractionated in the cation exchange chromatography described above. In addition, 35 mL of any one of the fractions was added to 633 mL of beer having an NIBEM value of 267 seconds. In addition, the NIBEM value of the beer after the addition was measured in the same manner as in Example 1 above.

As a result, the NIBEM value of the beer was increased by 17 seconds by adding the adsorbed fraction (“Adsorption (D4 to E2)” illustrated in FIG. 11) to the beer. Meanwhile, the NIBEM value of the beer was increased by 10 seconds by adding the non-adsorbed fraction (“Non-adsorption (C7)” illustrated in FIG. 11) to the beer.

Therefore, it was conceivable that the polypeptide included in the adsorbed fraction and having an isoelectric point of 4.9 to 5.4 contributed to the remarkable improvement of the foam-stability of the beer through the addition of the adsorbed fraction. Meanwhile, it was also conceivable that the polypeptide included in the non-adsorbed fraction contributed somewhat to the improvement of the foam-stability of the beer.

### Example 5

### Production of Sparkling Alcoholic Beverage

A sparkling alcoholic beverage was produced by the infusion method using a raw material containing a barley raw material composed of barley and barley malt, hops, and a protease in the same manner as in Example 1 above. The protease P5 (having a titer of 50,000 U/g) used in Example 1 above was used as the protease.

The amount of the protease added with respect to the barley raw material was set to 0.0025% by weight (0.0033% by weight with respect to the barley), 0.005% by weight (0.0066% by weight with respect to the barley), 0.01% by weight (0.013% by weight with respect to the barley), 0.025% by weight (0.033% by weight with respect to the barley), 0.05% by weight (0.066% by weight with respect to the barley), 0.1% by weight (0.13% by weight with respect to the barley), 0.25% by weight (0.33% by weight with respect to the barley), or 0.5% by weight (0.66% by weight with respect to the barley).

First, a raw material solution was prepared by adding the raw materials except the hops, that contained 830 g of the barley (77% by weight of the barley raw material), 250 g of the barley malt (23% by weight of the barley raw material), and the protease in an amount of any one of the eight types of % by weight with respect to the barley raw material, to hot water at 50° C.

In addition, eight types of sparkling alcoholic beverages were produced in the same manner as in Example 1 above. Further, a sparkling alcoholic beverage as a comparative control was produced in the same manner as above, except that no protease was used. Thus, nine types of sparkling alcoholic beverages were produced.

[Evaluation of NIBEM Value and Foam Adherence]

The NIBEM value of each of the nine types of sparkling alcoholic beverages produced as described above was measured in the same manner as in Example 1 above. Further, the foam adherence as one of the foam properties of each of the nine types of sparkling alcoholic beverages was evaluated using a commercially available measurement apparatus (Nibem Cling Meter manufactured by Haffmans). That is, the sparkling alcoholic beverage was poured in a glass, and after a predetermined period of time passed to disrupt the foam, a glass surface to which the foam had adhered was scanned optically. A rate of an area of a part covered with the foam with respect to a scanned total area was evaluated as the foam adherence (%). As the foam adherence (%) is higher, the foam adherence of the sparkling alcoholic beverage is better.

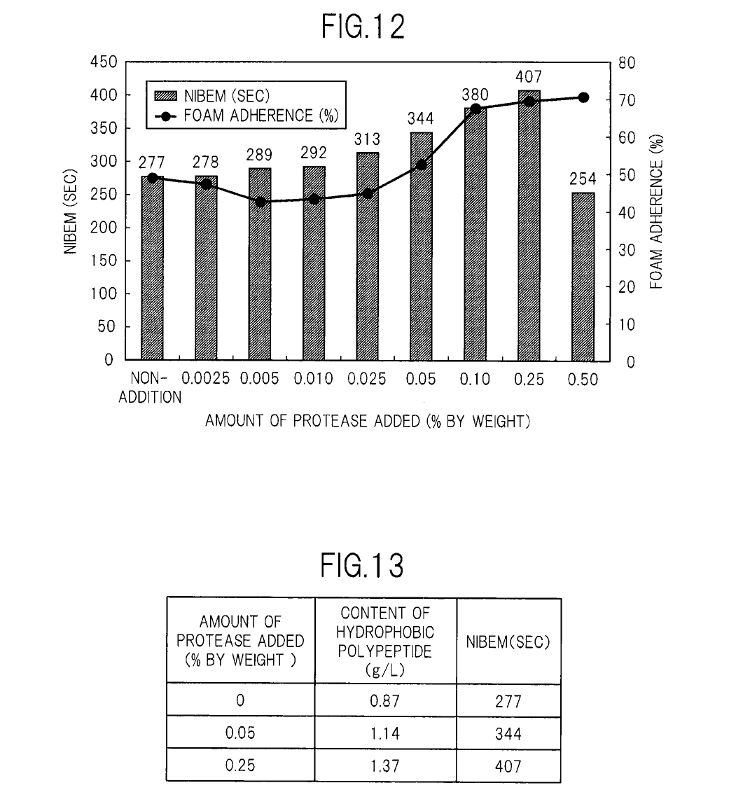

FIG. 12 illustrates results of evaluating the NIBEM value (seconds) and the foam adherence (%) for each of the nine types of sparkling alcoholic beverages with different amounts of the protease added (% by weight).

As illustrated in FIG. 12, the NIBEM value tended to increase as the amount of the protease added was increased. In this regard, however, when the amount of the protease added was 0.5% by weight, the NIBEM value was lower than that when the protease was not added (“Non-addition” in the figure).

Meanwhile, the foam adherence tended to slightly decrease when the amount of the protease added was small, but the foam adherence tended to increase as the amount of the protease added was increased when the amount was 0.05% by weight or more.

[Quantification of Polypeptide]

The sparkling alcoholic beverage produced using the protease P5 in an amount of 0.05% by weight or 0.25% by weight, and the sparkling alcoholic beverage produced using no protease, among the nine types of sparkling alcoholic beverages, were analyzed by reverse phase HPLC in the same manner as in Example 1 above. In addition, a fraction corresponding to the retention time range of 20 to 38 minutes containing the hydrophobic polypeptide was fractionated, and the polypeptide contained in the fraction was quantified in the same manner as in Example 1 above.

In FIG. 13, the amount of the protease P5 added (% by weight) used for the treatment of the barley, the content of the hydrophobic polypeptide (g/L), and the NIBEM value (seconds) in the sparkling alcoholic beverage for each of the three types of sparkling alcoholic beverages are illustrated in relation to each other. As illustrated in FIG. 13, the contents of the hydrophobic polypeptide and the NIBEM value in the sparkling alcoholic beverage were remarkably increased by increasing the amount of the protease added.

[Sensory Test]

A sensory test for each of the nine types of sparkling alcoholic beverages was performed by eight skilled panelists. That is, many parameters for the aroma, taste, and the like of the sparkling alcoholic beverage were comprehensively evaluated and scored by the panelists.

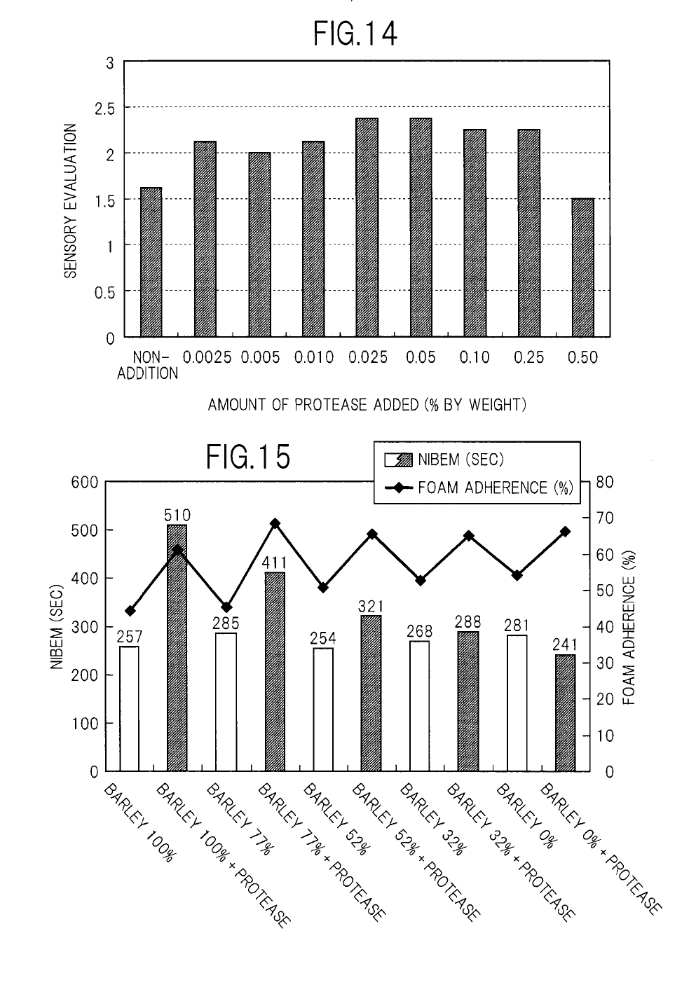

FIG. 14 illustrates the results of the sensory test. In FIG. 14, a vertical axis represents scores based on the evaluation obtained in the sensory test. A higher score means that a more preferred evaluation was obtained. The sensory evaluation of the sparkling alcoholic beverage was enhanced by treating the barley with the protease as illustrated in FIG. 14. In this regard, however, when the amount of the protease added was 0.5% by weight, the evaluation was lower than that when the protease was not added (“Non-addition” in the figure).

It should be noted that in addition to the above-mentioned results, it was confirmed that the following effects were obtained by the use of the protease. That is, for example, the amount of the extract contained in the pre-fermentation solution (wort) was increased as the amount of the protease added was increased. That is, the extract acquisition rate was enhanced by treating the barley with the protease.

Further, the number of days for the fermentation (days from the start of the fermentation with the addition of a yeast until an extract concentration in the fermentation solution was decreased to less than or equal to a predetermined value) was 6 days when no protease was added and when the amount of the protease added was 0.0025% by weight, whereas the number was able to be shortened by 1 day to 5 days when the amount of the protease added was 0.005% by weight or more. Further, the growth of a yeast was also facilitated by the addition of the protease. As described above, the effect of facilitating the fermentation was obtained by the addition of the protease. It should be noted that the amount of bubbles that occurred on water surface of the fermentation solution upon fermentation was also able to be reduced by the addition of the protease.

Further, an immature odor in the produced sparkling alcoholic beverage was effectively reduced by the addition of the protease. In particular, the immature odor in the sparkling alcoholic beverage was remarkably reduced, and the contents of ethyl acetate and isoamyl acetate that were good flavoring components were increased by adding the protease in an amount of 0.01% by weight or more. Further, the haze stability of the beer was also enhanced by the addition of the protease.

Further, the content of the 40-kDa protein in the sparkling alcoholic beverage was monotonically increased differently from the case of the hydrophobic polypeptide described above as the amount of the protease added was increased, and was maximized when the amount of the protease added was 0.5% by weight.

### Example 6

### Production of Sparkling Alcoholic Beverage

A sparkling alcoholic beverage was produced by the infusion method using a raw material containing a barley raw material composed of barley and/or barley malt, hops, and a protease in the same manner as in Example 1 above. The protease P5 used in Example 1 above was used as the protease.

The proportion between the barley and the barley malt in the barley raw material was as follows: 100% by weight of the barley (0% by weight of the barley malt); 77% by weight of the barley and 23% by weight of the barley malt; 52% by weight of the barley and 48% by weight of the barley malt; 32% by weight of the barley and 68% by weight of the barley malt; or 100% by weight of the barley malt (0% by weight of the barley).

First, a raw material solution was prepared by adding the raw materials except the hops, that contained 1,080 g of the barley raw material and 1.08 g of the protease (0.1% by weight with respect to the barley raw material), to hot water at 50° C.

In addition, five types of sparkling alcoholic beverages were produced in the same manner as in Example 1 above. Further, five types of sparkling alcoholic beverages as comparative controls were produced in the same manner as above except that no protease was used. Thus, ten types of sparkling alcoholic beverages were produced.

[Evaluation of NIBEM Value and Foam Adherence]

The NIBEM value and foam adherence of each of the ten types of sparkling alcoholic beverages produced as described above were evaluated in the same manner as in Example 5 above.

FIG. 15 illustrates results of evaluating the NIBEM value (seconds) and the foam adherence (%) for each of the ten types of sparkling alcoholic beverages, each having different proportions between the barley and the barley malt in the barley raw material.

As illustrated in FIG. 15, the NIBEM value when the barley raw material containing the barley was used was increased by treating the barley with the protease. Further, the rate of increase in the NIBEM value by the use of the protease tended to be increased as the proportion of the barley (i.e., the amount of the barley used) in the barley raw material was increased.

On the contrary, when no barley was contained in the barley raw material (“Barley 0%” in the figure), i.e., the barley malt alone was used, the NIBEM value was reduced by the use of the protease (“Barley 0%+Protease” in the figure).

Therefore, it was conceivable that the increase of the NIBEM value by the use of the protease was based on the action of the protease upon the barley, and the effect of the protease tended to be enhanced as the amount of the barley used was increased. Meanwhile, the foam adherence was enhanced by the use of the protease regardless of the amount of the barley used, even when no barley was used.

### Example 7

### Production of Sparkling Alcoholic Beverage

A sparkling alcoholic beverage was produced by the infusion method using a raw material containing a barley raw material composed of barley and barley malt, hops, and a protease. The proportion between the barley and the barley malt in the barley raw material was 52% by weight of the barley and 48% by weight of the barley malt. The protease P5 used in Example 1 above was used in an amount of 0.1% by weight with respect to the barley raw material as the protease.

First, the barley was treated with the protease without being mixed with the barley malt. That is, the raw materials except the hops and the barley malt, that is, 37.3 kg of the barley and the 37.3 g of the protease were mixed with hot water at 50° C. Then, the barley was treated with the protease by keeping the mixed solution containing the barley and the protease at 50° C. for 30 minutes. Subsequently, the protease was substantially inactivated by keeping the mixed solution at 70° C. for 15 minutes.

Then, the mixed solution containing the barley and the protease was kept at 65° C., and 34.5 kg of the barley malt was added thereto. In addition, saccharification was performed by keeping the resulting mixed solution at 65° C. for 60 minutes. The raw material solution after the saccharification was filtrated to obtain a pre-fermentation solution. Further, the pre-fermentation solution was heated up to 100° C., 420 g of the hops were added, and the whole was boiled. The pre-fermentation solution after the boiling was cooled.

The bottom-fermenting yeast was added to the cooled pre-fermentation solution to prepare a fermentation solution. Primary fermentation was performed by keeping the fermentation solution at a temperature of 10 to 12° C. for a predetermined period of time. Further, alcohol storage was performed by keeping the fermentation solution after the primary fermentation at a lower temperature for a predetermined period of time. The fermentation solution after the alcohol storage was filtrated to obtain a sparkling alcoholic beverage.

Further, a sparkling alcoholic beverage as a comparative control was produced in the same manner as above, except that no protease was used. Thus, two types of sparkling alcoholic beverages were produced. In addition, the NIBEM value of each of the two types of produced sparkling alcoholic beverages was evaluated in the same manner as in Example 1 above.

A sa result, the NIBEM value of the sparkling alcoholic beverage produced by treating the barley with the protease P5 was 276 seconds whereas the NIBEM value of the sparkling alcoholic beverage produced without treating the barley with the protease was 261 seconds. That is, the NIBEM value of the sparkling alcoholic beverage was increased by treating the barley with the protease without being mixed with the barley malt, compared to the case where the barley was not treated with the protease.

Further, FT-3 was carried out as an index of haze stability. That is, the sparkling alcoholic beverage produced using the barley treated with the protease (test product) and the sparkling alcoholic beverage produced using the barley not treated with the protease (control product) were each immersed in a water bath at 60° C. for 3 days and then kept at 0° C. for 1 day. Subsequently, turbidity was measured using a turbidity meter (manufactured by Haffmans, 90° scattered light was measured). As a result, the turbidity of the test product was 1.54° EBC whereas the turbidity of the control product was 4.36° EBC. Thus, the haze stability of the test product was confirmed to be enhanced by treating the barley with the protease.

### Example 8

### Evaluation of Hydrophobicity

The hydrophobicity of a hydrophobic polypeptide was evaluated quantitatively. That is, the degree of the hydrophobicity was evaluated by the sum of modified Rekker's constants. (Reference 1: R. F. Rekker, The Hydrophobic Fragmental Constant, Elsevier, Amsterdam, 1977, p. 301, Reference 2: Tatsuru Sasagawa et al., Prediction of Peptide Retention Times in Reversed-Phase High-Performance Liquid Chromatography during Linear Gradient elution, Journal of Chromatography 240 (1982), 329-340, Reference 3: Toshiaki Isobe, Norio Okuyama, Biophysical Chemistry Vol. 30, No. 1 (1986)).

The sum of modified Rekker's constants exhibits an exponential correlation with the retention time in reverse phase HPLC and can be regressed to the following equation (I) as described in Reference 2. It should be noted that as the hydrophobicity of a polypeptide or a protein is higher, its sum of modified Rekker's constants becomes larger.

[Math. 1]

RT=A ln(1+BΣDⱼnᵢⱼ)+C (I)

In the equation (I), “RT” represents the retention time, “ΣDⱼnᵢⱼ” represents the sum of modified Rekker's constants, and “A”, “B”, and “C” represent constants. “Dⱼ” represents the modified Rekker's constant of each amino acid, and “nᵢⱼ” represents the number of residues of each amino acid.

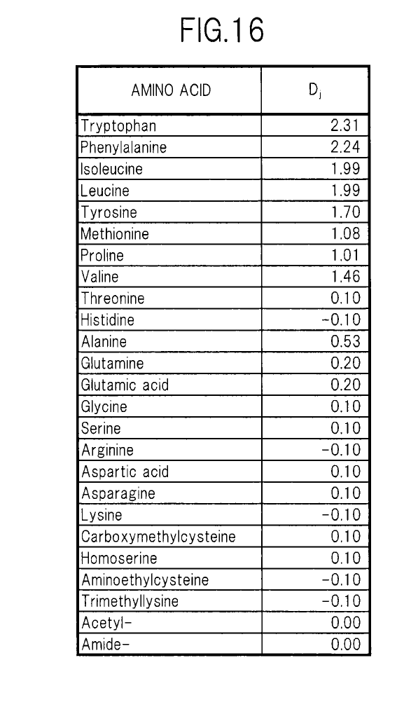

FIG. 16 illustrates the modified Rekker's constant of each amino acid (Dⱼ) (Reference 2: Tatsuru Sasagawa et al., Prediction of Peptide Retention Times in Reversed-Phase High-Performance Liquid Chromatography during Linear Gradient elution, Journal of Chromatography 240 (1982), 329-340). It should be noted that as the hydrophobicity of an amino acid is higher, its modified Rekker's constant becomes larger.

Thus, first, the correlation between the sum of modified Rekker's constants and the retention time in reverse phase HPLC was calculated using a plurality of peptides having known amino acid sequences that were different one another.

Peptides obtained by degrading bovine serum albumin (BSA) with trypsin and a commercially available peptide mixture (MassPREP Peptide Mixture manufactured by Nihon Waters K.K.) were used as the peptides. An amino acid sequence of degraded BSA with trypsin was determined by performing MS/MS measurement using an LC/MS/MS apparatus (ABI 3200 Qtrap manufactured by Applied Biosystems) and analyzing the measurement results using commercially available software (Protein Pilot, manufactured by Applied Biosystems). The analysis of these peptides by reverse phase HPLC was carried out in the same manner as in “Reverse phase chromatography” described above.

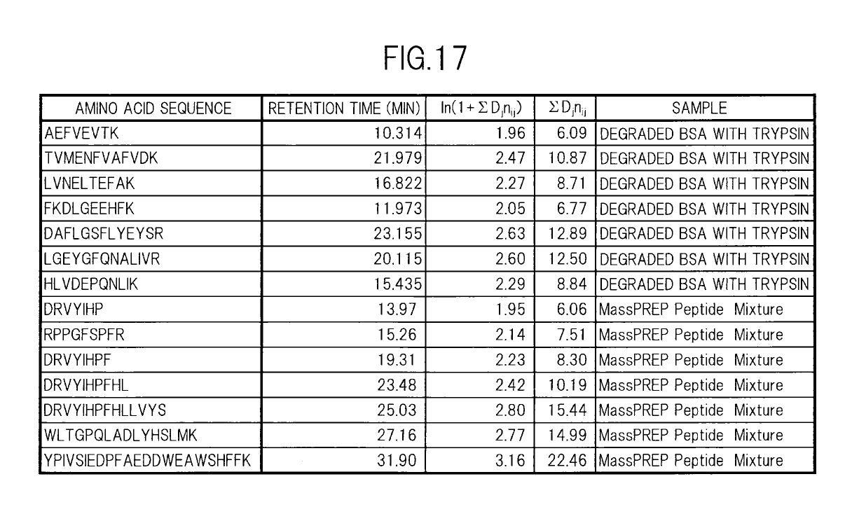

FIG. 17 illustrates the amino acid sequence, the retention time (minutes) in the reverse phase HPLC, a part of the first term on the right-hand side (ln(1+ΣDⱼnᵢⱼ) of the equation (I), the sum of modified Rekker's constants (ΣDⱼnᵢⱼ), and the origin of the amino acid (degraded BSA with trypsin or MassPREP Peptide Mixture) for each of the plurality of peptides subjected to the analysis.

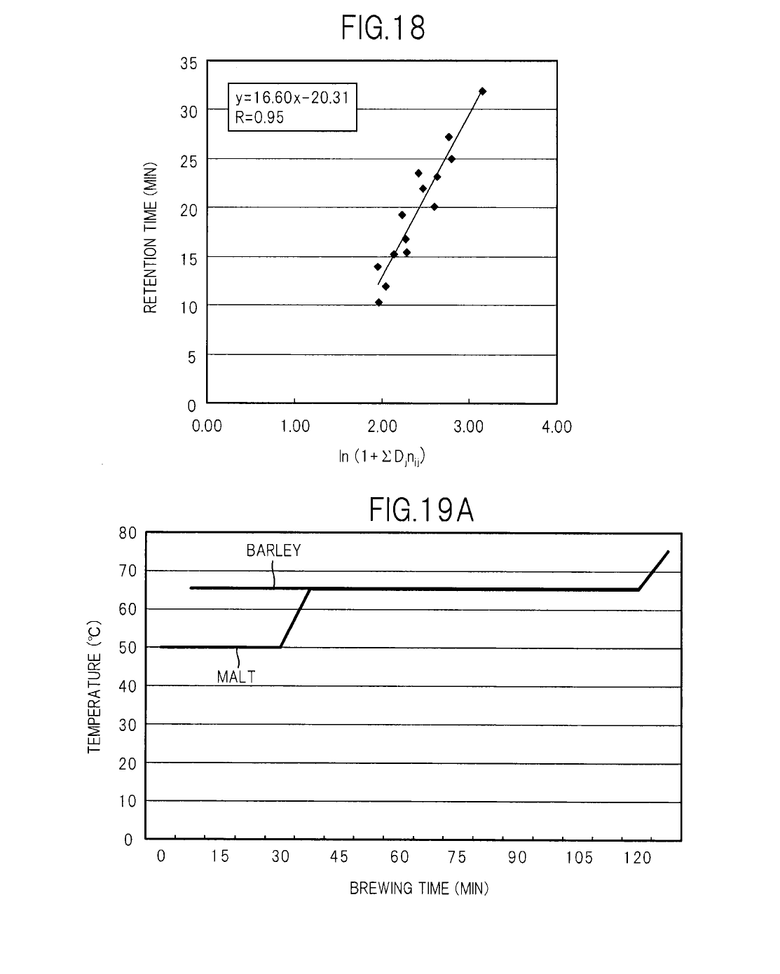

FIG. 18 illustrates a linear correlation between the part of the first term on the right-hand side (ln(1+ΣDⱼnᵢⱼ) of the equation (I) and the retention time in the reverse phase HPLC obtained based on the results illustrated in FIG. 17. That is, the high correlation as illustrated in FIG. 18 (R=0.95) was obtained by a least square method based on the results illustrated in FIG. 17 when the constant B was “1” in the equation (I), and the constants A and C in the equation (I) were determined to be “16.60” and “−20.31,” respectively.

In addition, the sum of modified Rekker's constants of a hydrophobic polypeptide eluted at a retention time of 20 minutes was calculated to be “10.3” based on the linear relation equation illustrated in FIG. 18. That is, a hydrophobic polypeptide eluted at a retention time of 20 minutes or more and improving the foam properties was defined as a polypeptide having a sum of modified Rekker's constants of “10.3” or more. Further, the sum of modified Rekker's constants of a hydrophobic polypeptide eluted at a retention time of 30 minutes was calculated to be “19.7” based on the linear relation equation described above.

### Example 9

A sparkling alcoholic beverage was produced by the infusion method using a raw material containing a barley raw material composed of barley and barley malt, hops, and a protease. The protease P5 used in Example 1 above was used as the protease.

### Example 9-1

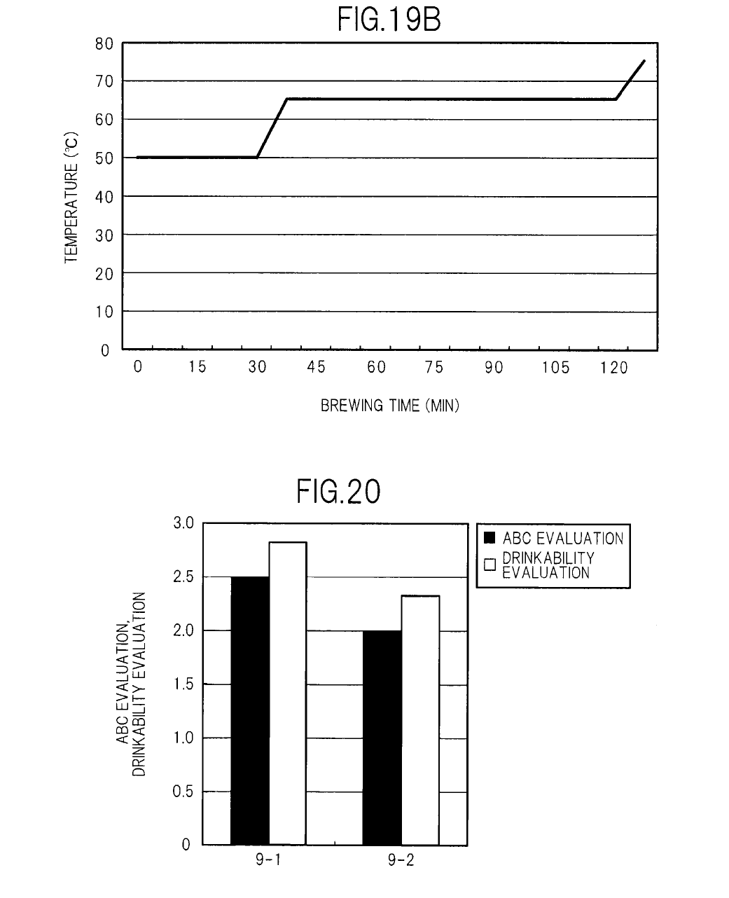

In Example 9-1, the treatment of the barley with the protease in a first tank and the treatment of the barley malt with the enzyme in a second tank were carried out in parallel according to a diagram illustrated in FIG. 19A to prepare a pre-fermentation solution. It should be noted that a mash tun was used as the first tank, and a mash kettle was used as the second tank.

First, 440 kg of the barley (52% by weight of the barley raw material) and 440 g of the protease (0.1% by weight with respect to the barley) were added to hot water at 65° C. in the first tank to prepare a barley composition. Then, as illustrated in FIG. 19A, the barley was treated with the protease by keeping the barley composition at 65° C. for 30 minutes (“Barley” illustrated in FIG. 19A).

Meanwhile, 405 kg of the barley malt (48% by weight of the barley raw material) was added to hot water at 50° C. in the second tank to prepare a malt composition. Then, as illustrated in FIG. 19A, a protein rest in which the barley malt was treated with an enzyme contained in the barley malt was performed by keeping the malt composition at 50° C. for 30 minutes (“Malt” illustrated in FIG. 19A).

Then, the malt composition was transferred from the second tank to the first tank while the malt composition was heated to increase its temperature up to 65° C. That is, the barley composition and the malt composition were mixed in the first tank.

In addition, saccharification was carried out by keeping the resulting mixture at 65° C. in the first tank. Then, the mixture was heated, kept at 76° C. for 1 minute, and subsequently filtrated. The mixture was further heated to 100° C., 4 kg of the hops was added, and the mixture was boiled. The mixture after the boiling was filtrated and cooled to obtain a pre-fermentation solution. Subsequently, alcoholic fermentation was performed to obtain a sparkling alcoholic beverage in the same manner as in Example 1 above.

### Example 9-2

In Example 9-2, the treatment of the barley and the barley malt with the protease and an enzyme contained in the barley malt were carried out in a mash tun according to a diagram illustrated in FIG. 19B to prepare a pre-fermentation solution. That is, first, the raw materials except the hops, that contained 440 kg of the barley (52% by weight of the barley raw material), 405 kg of the barley malt (48% by weight of the barley raw material), and 440 g of the protease (0.1% by weight with respect to the barley), were added to hot water at 50° C. to prepare a mixture. Then, as illustrated in FIG. 19B, the barley was treated with the protease and a protein rest was performed by keeping the mixture at 50° C. for 30 minutes.

Subsequently, saccharification was carried out by heating the mixture and keeping the mixture at 65° C. for 20 minutes. Then, the mixture was kept at 76° C. for 1 minute, and then filtrated. Further, the mixture was heated to 100° C., 4 kg of the hops were added, and the mixture was boiled. The mixture after the boiling was filtrated and cooled to obtain a pre-fermentation solution. Subsequently, alcoholic fermentation was performed to obtain the sparkling alcoholic beverage in the same manner as in Example 1 above.

[Evaluation of NIBEM Value]

The NIBEM value of each of the two types of sparkling alcoholic beverages obtained as described above was measured in the same manner as in Example 1 above. As a result, the NIBEM value of the sparkling alcoholic beverage produced in Example 9-1 was larger by 21 seconds than that of the sparkling alcoholic beverage produced in Example 9-2.

[Sensory Test]

Further, a sensory test for each of the two types of sparkling alcoholic beverages was performed by six skilled panelists. That is, many parameters for the aroma, taste, and the like of the sparkling alcoholic beverage were comprehensively evaluated and scored by the panelists (the evaluation was performed in three grades, i.e., A, B, and C, and hence is hereinafter referred to as “ABC evaluation”). Further, the drinkability of the sparkling alcoholic beverage was also evaluated, and scored. Here, a sparkling alcoholic beverage, another glass of which was desired after drinking one glass, was defined as a drinkable sparkling alcoholic beverage. In addition, a high score was given to a sparkling alcoholic beverage having high drinkability.

FIG. 20 illustrates the results of the sensory test. In FIG. 20, a horizontal axis represents the type of the sparkling alcoholic beverage (the sparkling alcoholic beverage produced in Example 9-1 is represented by “9-1,” and the sparkling alcoholic beverage produced in Example 9-2 is represented by “9-2”), and a vertical axis represents the score obtained by each of the ABC evaluation and drinkability evaluation. Further, the result of the ABC evaluation is represented by a solid bar, and the result of the drinkability evaluation is represented by an open bar.

As illustrated in FIG. 20, high scores in the ABC evaluation and the drinkability evaluation were obtained in both the sparkling alcoholic beverages. Further, the scores of the sparkling alcoholic beverage produced in Example 9-1 were much higher than those of the sparkling alcoholic beverage produced in Example 9-2 in both the ABC evaluation and the drinkability evaluation.

Further, the content of flavor components in each sparkling alcoholic beverage was measured. As a result, the content of isoamyl alcohol in the sparkling alcoholic beverage produced in Example 9-2 was higher than that in the sparkling alcoholic beverage produced in Example 9-1. Isoamyl alcohol is a component that gives an unfavorable effect on the flavor of a sparkling alcoholic beverage when its content becomes excessively high. Therefore, it was conceivable, as one of reasons for the high evaluation in the sensory test, that the increase of the content of isoamyl alcohol in the sparkling alcoholic beverage was effectively suppressed in Example 9-1.

As described above, the sparkling alcoholic beverage having both excellent foam properties and excellent flavor properties at particularly high levels was able to be produced by treating the barley with the protease in the first tank and treating the barley malt with the enzyme in the second tank.

### Example 10

A sparkling alcoholic beverage was produced by the infusion method using a raw material containing a barley raw material composed of barley and barley malt, hops, and a protease. The protease P5 used in Example 1 above was used as the protease.

### Example 10-1 (65)

In Example 10-1 (65), a sparkling alcoholic beverage was produced in the same manner as in Example 9-1 above, except that the proportion between the barley and the barley malt in the barley raw material was different.

More specifically, first, 830 g of the barley (77% by weight of the barley raw material) and 1.08 g of the protease (0.13% by weight with respect to the barley) were added to hot water at 65° C. in the first tank to prepare a barley composition. Then, as illustrated in FIG. 19A, the barley was treated with the protease by keeping this barley composition at 65° C. for 45 minutes.

Meanwhile, 250 g of the barley malt (23% by weight of the barley raw material) was added to hot water at 50° C. in the second tank to prepare a malt composition. Then, as illustrated in FIG. 19A, a protein rest in which the barley malt was treated with an enzyme contained in the barley malt was performed by keeping the malt composition at 50° C. for 30 minutes.

Subsequently, mixing of the barley composition and the malt composition, the saccharification of the resulting mixture by heating, the addition of the hops to the mixture, and boiling were carried out in the same manner as in Example 9-1 above to prepare a pre-fermentation solution. Then, alcoholic fermentation was carried out to obtain a sparkling alcoholic beverage.

### Example 10-1 (50)

In Example 10-1 (50), a sparkling alcoholic beverage was produced in the same manner as in Example 10-1 (65) above, except that the temperature at which the barley was treated with the protease was changed to 50° C.

### Example 10-2 (50)

In Example 10-2 (50), a sparkling alcoholic beverage was produced in the same manner as in Example 9-2 above, except that the proportions of the barley and the barley malt were different in the barley raw material.

More specifically, first, the raw materials except the hops, that contained 830 g of the barley (77% by weight of the barley raw material), 250 kg of the barley malt (23% by weight of the barley raw material), and 1.08 g of the protease (0.13% by weight of the barley), were loaded into hot water at 50° C. to prepare a mixture. Then, the barley was treated with the protease, and also the protein rest was performed by keeping the mixture at 50° C. for 30 minutes, as illustrated in FIG. 19B.

Subsequently, the saccharification of the resulting mixture by heating, the addition of the hops to the mixture, and the boiling were carried out in the same manner as in Example 9-2 above to prepare a pre-fermentation solution. Then, the alcoholic fermentation was carried out to obtain the sparkling alcoholic beverage.

### Example 10-2 (65)

In Example 10-2 (65), a sparkling alcoholic beverage was produced in the same manner as in Example 10-2 (50) above, except that the barley and the barley malt were treated with the protease and the enzyme contained in the barley malt, respectively, at a temperature of 65° C.

### Comparative Example

Further, a sparkling alcoholic beverage as a comparative control was produced in the same manner as in Example 10-2 (50) above, except that no protease was used.

[Evaluation of NIBEM Value]

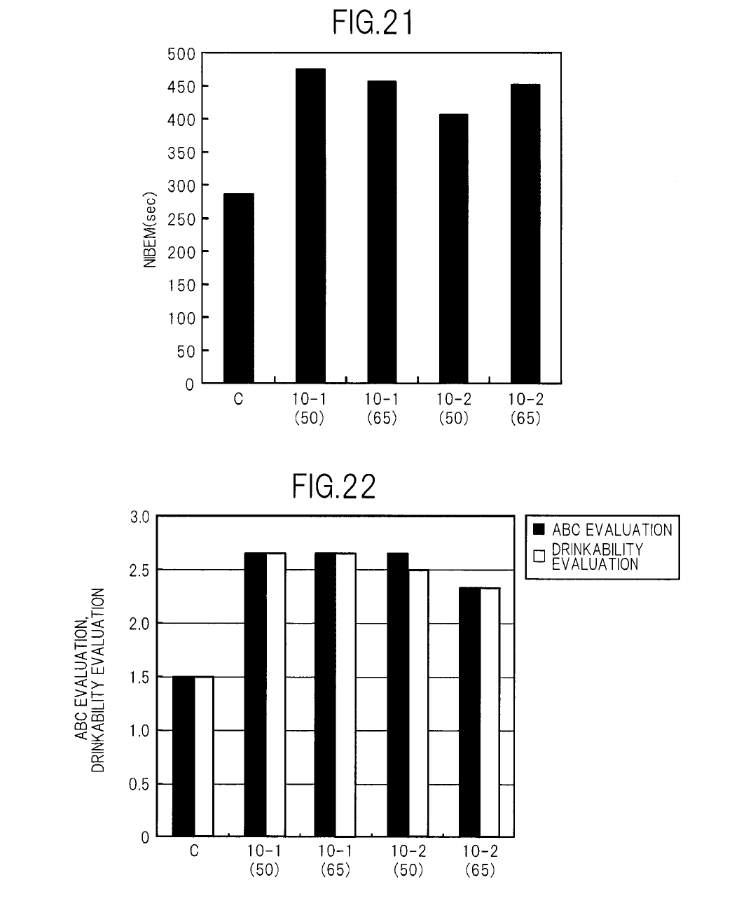

The NIBEM values of the five types of sparkling alcoholic beverages thus produced were evaluated in the same manner as in Example 1 above. FIG. 21 illustrates the results of measuring the NIBEM values. A horizontal axis represents the type of the sparkling alcoholic beverage (the sparkling alcoholic beverage produced in Comparative Example is represented by “C”), and a vertical axis represents the NIBEM value (seconds) in FIG. 21.

As illustrated in FIG. 21, the NIBEM values of all of the sparkling alcoholic beverages produced using the barley treated with the protease were remarkably larger than that of the sparkling alcoholic beverage produced using the barley not treated with the protease in the Comparative Example.

Further, the NIBEM value of the sparkling alcoholic beverage produced in Example 10-2 (50) was decreased compared to that of the sparkling alcoholic beverage produced in Example 10-2 (65). On the other hand, the NIBEM value of the sparkling alcoholic beverage produced in Example 10-1 (50) was equivalent to or higher than that of the sparkling alcoholic beverage produced in Example 10-1 (65).

More specifically, remarkably high NIBEM values were obtained regardless of the temperature for the treatment with the protease in Example 10-1 (50) and Example 10-1 (65) in each of which the treatment of the barley with the protease and the treatment of the barley malt with the enzyme were carried out in different tanks.

[Sensory Test]

Sensory tests (ABC evaluation and drinkability evaluation) were performed for the five types of the sparkling alcoholic beverages by six skilled panelists in the same manner as in Example 9 above.

FIG. 22 illustrates the results of the sensory tests. A horizontal axis represents the type of the sparkling alcoholic beverage and a vertical axis represents a score obtained in each of the ABC evaluation and the drinkability evaluation in FIG. 22. The result of the ABC evaluation is represented by a black bar, and the result of the drinkability evaluation is represented by an open bar.

As illustrated in FIG. 22, remarkably high scores were obtained in all of the sparkling alcoholic beverages produced using the barley treated with the protease compared to that of the sparkling alcoholic beverage produced using the barley not treated with the protease in the Comparative Example, in both the ABC evaluation and the drinkability evaluation.

Further, the scores of the sparkling alcoholic beverage produced in Example 10-2 (65) were lower than those of the sparkling alcoholic beverage produced in Example 10-2 (50). On the other hand, the scores of the sparkling alcoholic beverage produced in Example 10-1 (65) were equivalent to those of the sparkling alcoholic beverage produced in Example 10-1 (50).

More specifically, remarkably high scores were obtained regardless of the temperature for the treatment with the protease in Example 10-1 (50) and Example 10-1 (65) in each of which the treatment of the barley with the protease and the treatment of the barley malt with the enzyme were carried out in different tanks.

As describe above, the sparkling alcoholic beverage having both excellent foam properties and excellent flavor properties at high levels was able to be produced reliably regardless of the temperature for the treatment with the protease by performing the treatment of the barley with the protease and the treatment of the barley malt with the enzyme in different tanks.

1. A sparkling beverage, comprising from 1.1 g/L or more of a hydrophobic polypeptide.

2. The sparkling beverage of claim 1, wherein the hydrophobic polypeptide has a sum of modified Rekker's constants of 10.3 or more.

3. The sparkling beverage of claim 1, wherein the hydrophobic polypeptide has a proline content of 13.5 mol % or more.

4. The sparkling beverage of claim 1, wherein the hydrophobic polypeptide comprises a polypeptide having a molecular weight of 10 to 25 kDa.

5. The sparkling beverage of claim 1, wherein the hydrophobic polypeptide is a polypeptide obtained from barley.

6. A method of producing a sparkling beverage, the method comprising:
treating a raw material comprising barley with a protease, to produce a sparkling beverage comprising a hydrophobic polypeptide in an amount greater than the barley in the raw material.

7. The method of claim 6, wherein the raw material further comprises barley malt, and the treating is carried out without mixing the barley with the barley malt.

8. The method of claim 6, wherein the sparkling beverage has a hydrophobic polypeptide content increased by 0.05 g/L or more compared to the barley in the raw material.

9. A method of producing a sparkling beverage, the method comprising:
(I) treating, in a first tank, a barley composition comprising barley and a protease at a temperature at which the protease acts;
(II) treating, in a second tank, a malt composition comprising barley malt comprising an enzyme at a temperature at which the enzyme acts, in parallel with (I); and then
(III) mixing the barley composition treated with the protease with the malt composition treated with the enzyme.

10. An improving agent, comprising an active ingredient comprising a hydrophobic polypeptide.

11. A method improving the foam properties of a sparkling beverage, the method comprising:
treating a raw material comprising barley with a protease, to produce a sparkling beverage comprising a hydrophobic polypeptide in an amount greater than the barley in the raw material; or
adding the improving agent of claim 10 to a sparkling beverage.

12. The sparkling beverage of claim 2, wherein the hydrophobic polypeptide has a proline content of 13.5 mol % or more.

13. The sparkling beverage of claim 3, wherein the hydrophobic polypeptide comprises a polypeptide having a molecular weight of 10 to 25 kDa.

14. The sparkling beverage of claim 3, wherein the hydrophobic polypeptide comprises a polypeptide having a molecular weight of 10 to 25 kDa.

15. The sparkling beverage of claim 2, wherein the hydrophobic polypeptide is a polypeptide obtained from barley.

16. The sparkling beverage of claim 3, wherein the hydrophobic polypeptide is a polypeptide obtained from barley.

17. The sparkling beverage of claim 4, wherein the hydrophobic polypeptide is a polypeptide obtained from barley.

18. The method of claim 7, wherein the sparkling beverage has a hydrophobic polypeptide content increased by 0.05 g/L or more compared to the barley in the raw material.
